(19) United States
(12) Patent Application Publication
(10) Pub. No.: US 2012/0119118 A1
(43) Pub. Date: May 17, 2012

(54) EXTREME ULTRAVIOLET LIGHT SOURCE SYSTEM

(75) Inventors: Yukio WATANABE, Hiratsuka (JP); Osamu Wakabayashi, Hiratsuka (JP); Junichi Fujimoto, Oyama (JP); Toshihiro Nishisaka, Hiratsuka (JP); Hiroshi Someya, Hiratsuka (JP); Hideo Hoshino, Hiratsuka (JP)

(73) Assignee: Gigaphoton Inc., Tokyo (JP)

(21) Appl. No.: 13/359,315

(22) Filed: Jan. 26, 2012

Related U.S. Application Data
(63) Continuation of application No. 12/685,835, filed on Jan. 12, 2010.

(30) Foreign Application Priority Data
Jan. 14, 2009 (JP) 2009-005639
Jun. 25, 2009 (JP) 2009-151445
Dec. 22, 2009 (JP) 2009-290771

(51) Int. Cl. G21K 5/00

(52) U.S. Cl. 250/504 R

(57) ABSTRACT

An extreme ultraviolet (EUV) light source system in which parts of an EUV light source apparatus can easily be replaced. The system includes: (i) an extreme ultraviolet light source apparatus having a chamber in which extreme ultraviolet light is generated, a target supply unit for supplying a target material into the chamber, a driver laser for irradiating the target material supplied by the target supply unit with a laser beam to generate plasma, and a collector mirror for collecting the extreme ultraviolet light radiated from the plasma to allow the extreme ultraviolet light to enter projection optics of exposure equipment; and (ii) a lifting apparatus provided to lift and move a replacement part which is a part of the extreme ultraviolet light source apparatus.

### CROSS-REFERENCE TO RELATED APPLICATION

The present application claims priority from Japanese Patent Applications No. 2009-005639 filed on Jan. 14, 2009, No. 2009-151445 filed on Jun. 25, 2009, and No. 2009-290771 filed on Dec. 22, 2009, the contents of which are incorporated herein by reference in their entirety.

### BACKGROUND OF THE INVENTION

1. Field of the Invention

The present invention relates to an extreme ultraviolet (EUV) light source system including an extreme ultraviolet light source apparatus to be used as a light source of exposure equipment.

2. Description of a Related Art

In recent years, as semiconductor processes become finer, photolithography has been making rapid progress toward finer fabrication. In the next generation, microfabrication at 60 nm to 45 nm, further, microfabrication at 32 nm and beyond will be required. Accordingly, in order to fulfill the requirement for microfabrication at 32 nm and beyond, for example, exposure equipment is expected to be developed by combining an EUV light source for generating EUV light having a wavelength of about 13 nm and reduced projection reflective optics.

As the EUV light source, there are three kinds of light sources, which include an LPP (laser produced plasma) light source using plasma generated by irradiating a target with a laser beam, a DPP (discharge produced plasma) light source using plasma generated by discharge, and an SR (synchrotron radiation) light source using orbital radiation. Among them, the LPP light source has advantages that extremely high intensity close to blackbody radiation can be obtained because plasma density can be considerably made higher, that the light of only the particular waveband can be radiated by selecting the target material, and that an extremely large collection solid angle of 2π to 4π steradian can be ensured because it is a point source having substantially isotropic angle distribution and there is no structure such as electrodes surrounding the light source. Therefore, the LPP light source is considered to be predominant as a light source for EUV lithography, which requires power of more than several tens of watts.

In the LPP type EUV light source apparatus, EUV light is generated on the following principle. That is, a target material is supplied into a vacuum chamber by using a nozzle, and the target material is irradiated with a laser beam, and thereby, the target material is excited and turned into plasma. From thus generated plasma, various wavelength components including EUV light are radiated. Accordingly, EUV light is reflected and collected by using a collector mirror for selectively reflecting a specific wavelength component of them (e.g., a component having a wavelength of 13.5 nm), and outputted to projection optics of exposure equipment. For example, as a collector mirror for collecting EUV light having a wavelength of about 13.5 nm, a mirror having a reflection surface on which molybdenum (Mo) and silicon (Si) coatings are alternately stacked is used. Typically, the number of stacked Mo/Si thin coatings is 60 to several hundreds.

As a related technology, Japanese Patent Application Publication JP-P2006-108686A discloses a lithography apparatus for irradiating a virtual light source point of projection optics with EUV light in alignment with the optical axis of the projection optics by providing an oblique incident mirror within an EUV light source apparatus (radiation unit).

However, in the lithography apparatus of JP-P2006-108686A, loss of EUV light intensity occurs because the oblique incident mirror is provided. Generally, the reflectivity of EUV light by a mirror is about 60%, and as the number of mirrors increases by one, the use efficiency of EUV light becomes lower to about 60%.

Further, U.S. Patent Application Publication US 2006/0146143 A1 discloses a lithographic apparatus for irradiating a virtual light source point of projection optics with EUV light in alignment with the optical axis of the projection optics by installing an EUV light source apparatus obliquely relative to the direction of gravitational force. According to US 2006/0146143 A1, the number of reflection mirrors is smaller by one compared to that of JP-P2006-108686A, and the use efficiency of EUV light can be improved.

However, in the lithographic apparatus of US 2006/0146143 A1, the EUV light source apparatus is placed in the lower position than the projection system of the exposure equipment. The replacement parts of the EUV light source apparatus such as a chamber are heavy, and replacement of the parts at maintenance is not easy in the EUV light source apparatus placed in the lower position.

### SUMMARY OF THE INVENTION

The present invention has been achieved in view of the above-mentioned problems. A purpose of the present invention is to provide an extreme ultraviolet (EUV) light source system in which parts of an EUV light source apparatus can easily be replaced.

In order to accomplish the above-mentioned purpose, an extreme ultraviolet light source system according to one aspect of the present invention includes (i) an extreme ultraviolet light source apparatus having a chamber in which extreme ultraviolet light is generated, a target supply unit for supplying a target material into the chamber, a driver laser for irradiating the target material supplied by the target supply unit with a laser beam to generate plasma, and a collector mirror for collecting the extreme ultraviolet light radiated from the plasma to allow the light to enter projection optics of exposure equipment; and (ii) a lifting apparatus provided to lift and move a replacement part which is a part of the extreme ultraviolet light source apparatus.

According to the one aspect of the present invention, since the lifting apparatus is provided to lift and move a replacement part which is a part of the EUV light source apparatus, the replacement part which is a heavy unit can be replaced easily at maintenance of the EUV light source apparatus.

### BRIEF DESCRIPTION OF THE DRAWINGS

FIGS. 1A and 1B are a plan view and a side view showing a schematic configuration of exposure equipment including an extreme ultraviolet (EUV) light source system according to the first embodiment of the present invention;

FIG. 2 is a schematic diagram showing a configuration of an EUV light source apparatus included in the EUV light source system;

FIG. 3 is a plan view showing an alternate example of a configuration for moving a lifted replacement part in the first embodiment;

FIG. 4 is a plan view showing another alternate example of the configuration for moving a lifted replacement part in the first embodiment;

FIG. 5 is a plan view showing still another alternate example of the configuration for moving a lifted replacement part in the first embodiment;

FIG. 6 is a side view showing a first example of the EUV light source system according to the first embodiment;

FIG. 7 is a side view showing a second example of the EUV light source system according to the first embodiment;

FIG. 8 is a side view showing a third example of the EUV light source system according to the first embodiment;

FIG. 9 is a side view showing a fourth example of the EUV light source system according to the first embodiment;

FIG. 10 is a side view showing a fifth example of the EUV light source system according to the first embodiment;

FIG. 11 is a side view showing a sixth example of the EUV light source system according to the first embodiment;

FIG. 12 is a side view showing a seventh example of the EUV light source system according to the first embodiment;

FIG. 13 is a side view showing an eighth example of the EUV light source system according to the first embodiment;

FIG. 14 is a side view showing a ninth example of the EUV light source system according to the first embodiment;

FIG. 15 is a side view showing a tenth example of the EUV light source system according to the first embodiment;

FIG. 16 is a side view showing an eleventh example of the EUV light source system according to the first embodiment;

FIG. 17 is a side view showing a twelfth example of the EUV light source system according to the first embodiment;

FIGS. 18A and 18B are a side view and a front view showing a thirteenth example relating to an EUV chamber carriage in the first embodiment;

FIGS. 19A and 19B are a side view and a front view showing a fourteenth example relating to the EUV chamber carriage in the first embodiment;

FIGS. 20A and 20B are a side view and a front view showing a fifteenth example relating to the EUV chamber carriage in the first embodiment;

FIGS. 21A and 21C are side views showing a sixteenth example relating to an EUV chamber carriage in the first embodiment, and FIGS. 21B and 21D are front views showing the sixteenth example relating to the EUV chamber carriage in the first embodiment;

FIGS. 22A and 22B are side views showing a schematic configuration of an extreme ultraviolet (EUV) light source system according to the second embodiment of the present invention;

FIGS. 23A and 23B are side views showing the sixteenth example relating to the movement mechanism in the EUV light source system according to the second embodiment;

FIGS. 24A-24C are a plan view showing a seventeenth example of the EUV light source system according to the second embodiment, a sectional view along A-A line in FIG. 24A, and a side view;

FIGS. 25A-25C are a plan view showing an eighteenth example of the EUV light source system according to the second embodiment, a sectional view along B-B line in FIG. 25A, and a side view;

FIGS. 26A-26C are a plan view showing a nineteenth example of the EUV light source system according to the second embodiment, a sectional view along C-C line in FIG. 26A, and a side view;

FIGS. 27A-27C are a plan view showing a twentieth example of the EUV light source system according to the second embodiment, a sectional view along D-D line in FIG. 27A, and a side view;

FIGS. 28A and 28B are side views showing a twenty-first example of the EUV light source system according to the second embodiment;

FIGS. 29A and 29B are side views showing a twenty-second example of the EUV light source system according to the second embodiment;

FIGS. 30A and 30B are side views showing a twenty-third example of the EUV light source system according to the second embodiment;

FIGS. 31A and 31B are side views showing a twenty-fourth example of the EUV light source system according to the second embodiment; and

FIGS. 32A and 32B are side views showing a twenty-fifth example of the EUV light source system according to the second embodiment.

### DESCRIPTION OF THE PREFERRED EMBODIMENTS

Hereinafter, preferred embodiments of the present invention will be explained in detail by referring to the drawings. The same reference numerals are assigned to the same component elements and the duplicated explanation thereof will be omitted.

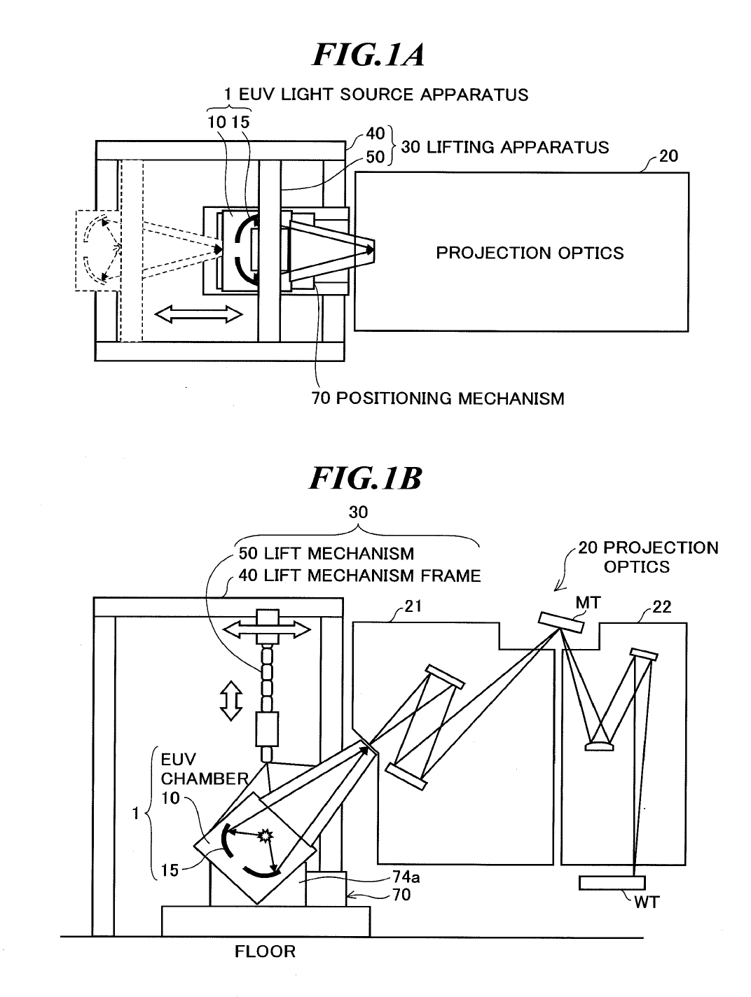

FIGS. 1A and 1B are a plan view and a side view showing a schematic configuration of exposure equipment including an extreme ultraviolet (EUV) light source system according to the first embodiment of the present invention. The exposure equipment includes an EUV light source apparatus 1, projection optics 20, a lifting apparatus 30, and a positioning mechanism 70. Here, the projection optics 20 includes a mask irradiation unit 21 as optics for irradiating a mask with EUV light, and a workpiece irradiation unit 22 as optics for projecting an image of the mask on a workpiece such as a wafer. The EUV light source apparatus 1, the lifting apparatus 30, and the positioning mechanism 70 form an extreme ultraviolet light source system.

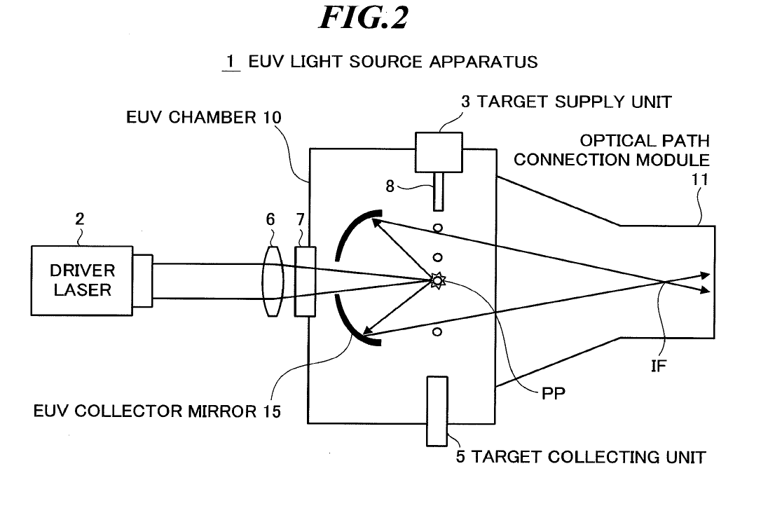

FIG. 2 is a schematic diagram showing a configuration of the EUV light source apparatus included in the EUV light source system.

The EUV light source apparatus 1 employs a laser produced plasma (LPP) type for generating EUV light by irradiating a target material with a laser beam to excite the target material. As shown in FIG. 2, the EUV light source apparatus 1 includes a driver laser 2, a target supply unit 3, a target collecting unit 5, a laser beam focusing optics 6, an EUV chamber 10, an optical path connection module 11, and an EUV collector mirror 15.

The driver laser 2 is a master oscillator power amplifier type laser apparatus for generating a drive laser beam to be used for exciting the target material. The laser beam generated by the driver laser 2 is focused to form a focus on a trajectory (track) of the target material within the EUV chamber 10 by the laser beam focusing optics 6 including at least one lens and/or at least one mirror. When the laser beam is focused and applied onto the target, plasma is generated. From the plasma emission point (PP), EUV light is radiated.

The target supply unit 3 is a unit for supplying the target material such as tin (Sn), lithium (Li), or the like to be used for generation of the EUV light into the EUV chamber 10 via a target nozzle 8. Among the supplied target materials, the target materials, which have not been irradiated with the laser beam and become unnecessary, are collected by the target collecting unit 5.

The state of the target material may be a solid, liquid, or gas state, and the target supply unit 3 may supply the target material to a space within the EUV chamber 10 in any known form such as continuous flow (target jet) or droplets. For example, in the case where a molten metal of tin (Sn) is used as the target material, the target supply unit 3 includes a heater for melting tin, a compressed gas cylinder for supplying a high-purity argon (Ar) gas to inject the molten metal of tin, a mass-flow controller, a target nozzle, and so on. Further, when droplets are produced, a vibrating device such as a piezoelectric element is added to the target nozzle 8.

The EUV chamber 10 is a vacuum chamber in which EUV light is generated. The EUV chamber 10 is provided with a window 7 for passing the laser beam generated by the driver laser 2 into the EUV chamber 10.

The EUV collector mirror 15 is provided within the EUV chamber 10. The EUV collector mirror 15 has a reflection surface coated with a multilayer coating for selectively reflecting EUV light having a specific wavelength. The reflection surface of the EUV collector mirror 15 has a spheroidal shape, and the EUV collector mirror 15 is arranged such that the first focus of the spheroid is located at the plasma emission point (PP). The EUV light reflected by the EUV collector mirror 15 is collected to the second focus of the spheroid, i.e., the intermediate focusing point IF.

By irradiating the target material supplied into the EUV chamber 10 with the laser beam, plasma is generated, and light having various wavelength components is radiated from the plasma. A specific wavelength component of them (e.g., a component having a wavelength of 13.5 nm) is reflected and collected by the EUV collector mirror 15. The EUV light outputted from the EUV collector mirror 15 passes through the optical path connection module 11 for connecting the EUV chamber 10 and the projection optics 20 to each other, and enters the projection optics 20.

Referring to FIGS. 1A and 1B again, the projection optics 20 includes a mask irradiation part 21 for irradiating a mask with EUV light and a workpiece irradiation part 22 for projecting an image of the mask on a workpiece such as a wafer. The mask irradiation part 21 applies the EUV light entering from the EUV light source apparatus 1 onto a mask pattern of a mask on a mask table MT via a reflective optics. The workpiece irradiation part 22 focuses the EUV light reflected from the mask onto a workpiece (semiconductor wafer or the like) on a workpiece table WT via a reflective optics. By simultaneously performing parallel translation of the mask table MT and the workpiece table WT, the mask pattern is transferred to the workpiece.

The lifting apparatus 30 is an apparatus for lifting and moving a replacement part (EUV chamber 10 or the like) which is apart of the EUV light source apparatus 1, and includes a lift mechanism 50 for lifting the replacement part and a lift mechanism frame 40 for supporting the lift mechanism 50. The replacement part may include not only the EUV chamber 10, but also a part or whole of the driver laser 2, the target supply unit 3, the target collecting unit 5, the laser beam focusing optics 6, the optical path connection module 11, or a peripheral unit (not shown) such as a power supply unit, a vacuum evacuation pump, a magnetic field generating unit, or the like.

The details of the mechanism for lifting and moving the replacement part will be described later. As a configuration for lifting the replacement part, not only a configuration for hoisting the replacement part by using a crane as shown in FIGS. 1A and 1B, but also a configuration for pushing up or pulling up the replacement part along a slope, a configuration for lifting the replacement part by picking up the replacement part such as a forklift, or the like may be used. Alternatively, a mechanism for pushing up the replacement part from below or the like may be used.

As a configuration for moving the lifted replacement part, a configuration in which the lift mechanism 50, which has lifted the replacement part, moves in a direction orthogonal to the direction of gravity force along rails of the lift mechanism frame 40 or the like, a configuration in which the lift mechanism 50 performs rotational movement around an axis passing through one point within the lift mechanism frame 40, a configuration in which the lift mechanism frame 40 itself moves in a direction orthogonal to the direction of gravity force relative to the projection optics 20, or the like may be used. FIGS. 1A and 1B show an example in which the lift mechanism 50 moves together with the replacement part in parallel to a direction toward the projection optics 20. More specifically, the lift mechanism 50 is provided over two parallel beam members of the lift mechanism frame 40, and the lift mechanism 50 moves on the rails respectively provided along the two beam members.

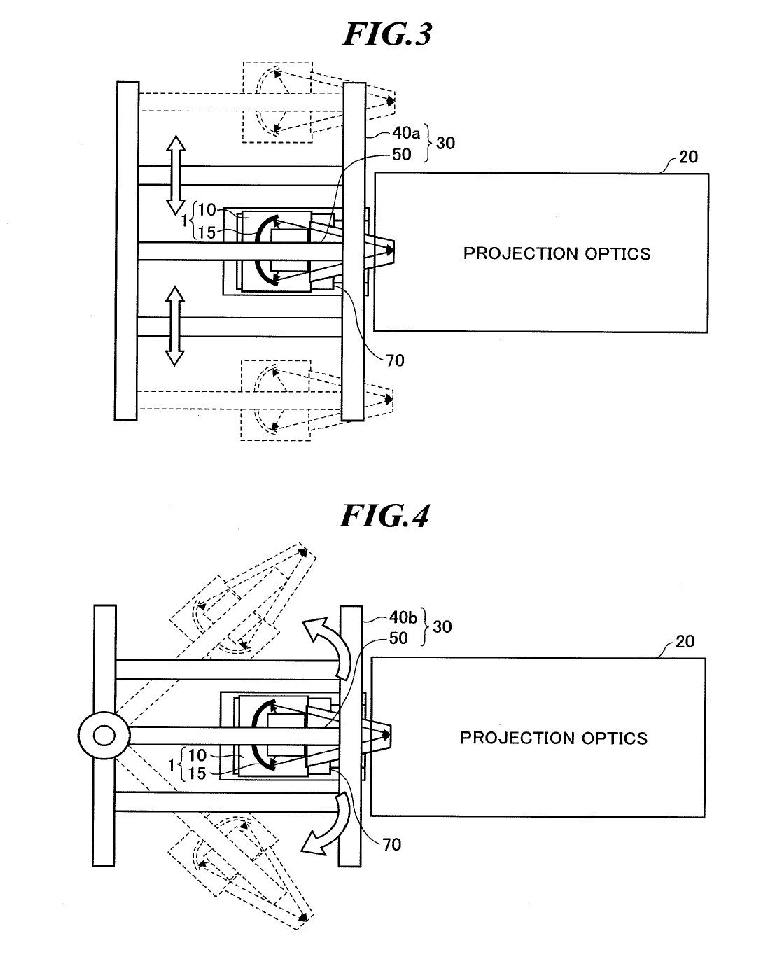

FIG. 3 is a plan view showing a configuration example for moving the lifted replacement part in the first embodiment, and shows an alternate example of FIG. 1A. FIG. 3 shows an example in which the lift mechanism 50 moves together with the replacement part in a direction orthogonal to the direction toward the projection optics 20. More specifically, the lift mechanism 50 is provided over two parallel beam members of a lift mechanism frame 40a, and the lift mechanism 50 moves on the rails respectively provided along the two beam members.

FIG. 4 is a plan view showing a configuration example for moving the lifted replacement part in the first embodiment, and shows another alternate example of FIG. 1A. FIG. 4 shows an example in which the lift mechanism 50 rotates and the replacement part moves while describing an arc trajectory (track). More specifically, the lift mechanism 50 is provided rotatably around an axis passing through one point within a lift mechanism frame 40b, and the replacement part is moved by the rotational movement of the lift mechanism 50.

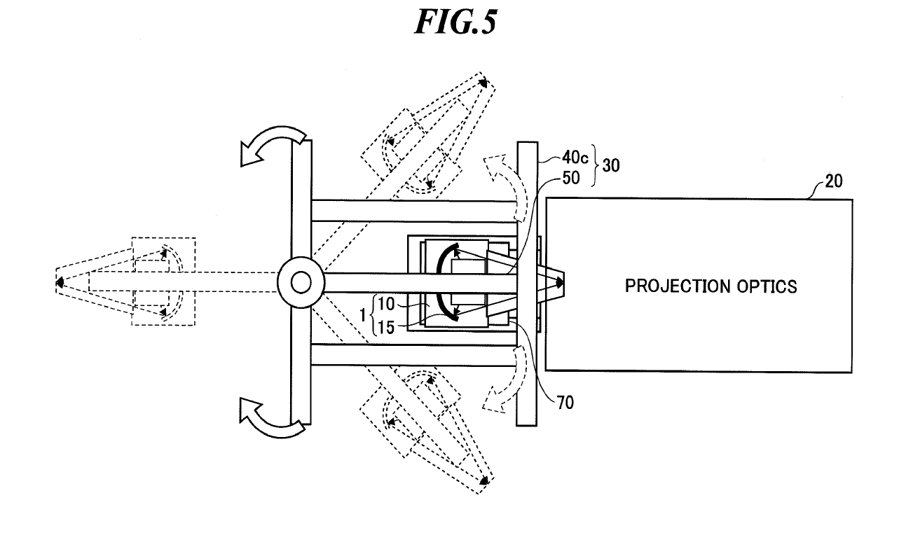

FIG. 5 is a plan view showing a configuration example for moving the lifted replacement part in the first embodiment, and shows still another alternate example of FIG. 1A. FIG. 5 shows an example in which the lift mechanism 50 rotates and the replacement part moves while describing an arc trajectory (track). More specifically, the lift mechanism 50 is provided rotatably around an axis passing through one point within a lift mechanism frame 40c by 180° or more, and the replacement part is moved when the lift mechanism 50 rotates in a direction nearly opposite to the initial direction.

Referring to FIGS. 1A and 1B again, the positioning mechanism 70 includes a chamber stage 74a conformed to the shape of the EUV chamber 10. The chamber stage 74a holds the EUV chamber 10 in a position oblique to the direction of gravity force such that the optical axis of EUV light outputted from the EUV chamber 10 (hereinafter, referred to as “optical axis of the EUV chamber 10”) is aligned with the optical axis of the projection optics 20. Since the chamber stage 74a is conformed to the shape of the EUV chamber 10, the EUV chamber 10 is fit in the chamber stage 74a, and thereby, the position, in which the optical axis of the EUV chamber 10 is aligned with the optical axis of the projection optics 20, can precisely be held.

The positioning mechanism 70 positions the chamber stage 74a such that the EUV chamber 10 is positioned in the position in which the optical axis of the EUV chamber 10 is aligned with the optical axis of the projection optics 20. The configuration for positioning the chamber stage 74a is not particularly limited, but various configurations such as a stopper, a positioning pin, a six-axis stage may be used. FIGS. 1A and 1B show the condition in which the EUV chamber 10 is positioned together with the chamber stage 74a in the position in which the optical axis of the EUV chamber 10 is aligned with the optical axis of the projection optics 20.

Due to the above-mentioned configuration, according to the embodiment, a part such as the EUV chamber 10 as a heavy unit can be replaced easily at maintenance of the EUV light source apparatus 1. Further, the time required for replacement of the part can be shortened. Furthermore, the safety of part replacement work can be improved. In addition, since the lifting apparatus 30 is provided, the effort of carrying heavy tools for part replacement to the EUV light source apparatus 1, in which part replacement is performed, can be reduced.

Next, specific examples of the EUV light source system according to the above-mentioned first embodiment will be explained. The explanation of the above-mentioned first embodiment applies to the following respective examples without change unless it goes against their nature.

FIG. 6 is a side view showing a first example of the EUV light source system according to the first embodiment.

In the EUV light source system according to the first example, a lift mechanism frame 41 is integrated with the frame of the EUV light source apparatus 1. In the first example, since the lift mechanism frame 41 is indivisibly integrated with the frame of the EUV light source apparatus 1, the lift mechanism frame 41 is shown in the EUV light source apparatus 1. A movement mechanism 60 for moving the replacement part such as the EUV chamber 10 is fixed to the lift mechanism frame 41 integrated with the EUV light source apparatus frame. The replacement part such as the EUV chamber 10 is placed on the chamber stage 74a, and the chamber stage 74a moves on the movement mechanism 60, and thereby, the replacement part moves between the location where the optical axis of the EUV chamber 10 is aligned with the optical axis of the projection optics and the location at a predetermined distance apart from the projection optics.

The configuration of the movement mechanism 60 is not particularly limited, but, for example, the rails provided on the lift mechanism frame 41 may be the movement mechanism 60. The chamber stage 74a travels on the rails, and thereby, the chamber stage 74a can move with the replacement part such as the EUV chamber 10.

When the replacement part of the EUV light source apparatus 1 is carried out for maintenance, first, the replacement part is moved to a location at a predetermined distance apart from the projection optics by the movement mechanism 60, and then, the replacement part is lifted by the lift mechanism 50. Then, the lift mechanism 50 is moved, and thereby, the replacement part is moved to an EUV chamber carriage 80 located apart from the movement mechanism 60. The replacement part mounted on the EUV chamber carriage 80 is carried to a desired maintenance area. Here, the case where the replacement part is lifted by the lift mechanism 50 after the replacement part is moved to the location at the predetermined distance apart from the projection optics by the movement mechanism 60 has been explained. This is for preventing contact between the replacement part and the projection optics and damage of either one of them when replacement part is lifted by the lift mechanism 50. Depending on the shape of the projection optics, in the case where the contact with the projection optics can be avoided even when the replacement part is not moved by the movement mechanism 60 but lifted as it is, the movement mechanism 60 can be omitted.

When the replacement part is placed in the EUV light source apparatus 1, the EUV chamber carriage 80 with mounted replacement part is moved within a movable range of the lift mechanism 50, and then, the replacement part is supported by the lift mechanism 50 and moved to a location above the movement mechanism 60. When the replacement part reaches the location above the movement mechanism 60, the lift mechanism 50 moves down the replacement part on the movement mechanism 60. The replacement part, which has been moved down on the movement mechanism 60, is moved by the movement mechanism 60 to a location where the optical axis of the EUV chamber 10 is aligned with the optical axis of the projection optics.

According to the first example, since the lift mechanism frame 41 and the frame of the EUV light source apparatus 1 are integrated, the location alignment of the lift mechanism 50 can be performed with high accuracy.

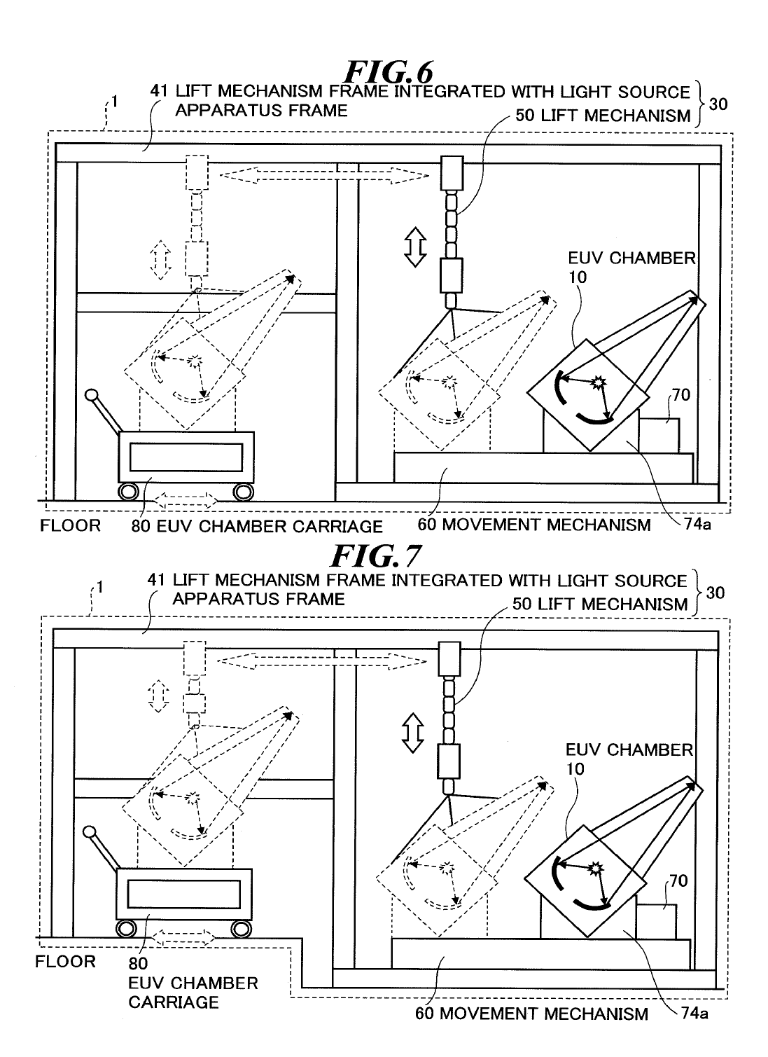

FIG. 7 is a side view showing a second example of the EUV light source system according to the first embodiment.

The second example is different from the first example in that the floor surface (hereinafter, referred to “lower floor surface”) in the location where the optical axis of the EUV chamber 10 is aligned with the optical axis of the projection optics is lower than the floor surface (hereinafter, referred to “higher floor surface”) in a region where the EUV chamber 10 can be transported by the EUV chamber carriage 80. The rest of the configuration is the same as that of the first example. The lift mechanism frame 41 in the second example is provided over the lower floor surface and the higher floor surface, and the column member located at the lower floor surface side of the lift mechanism frame 41 is longer and projected downward relative to the column member located at the higher floor surface side of the lift mechanism frame 41.

Therefore, in the second example, the movement of the replacement part within the region of the lower floor surface is performed by the movement mechanism 60, the movement from the region of the lower surface to the region of the upper surface is performed by the lifting apparatus 30, and the movement within the region of the upper surface is performed by the EUV chamber carriage 80.

Since the second example has the above-mentioned configuration, the replacement part can be moved easily to the location at a different floor surface height in addition to the advantage of the first example.

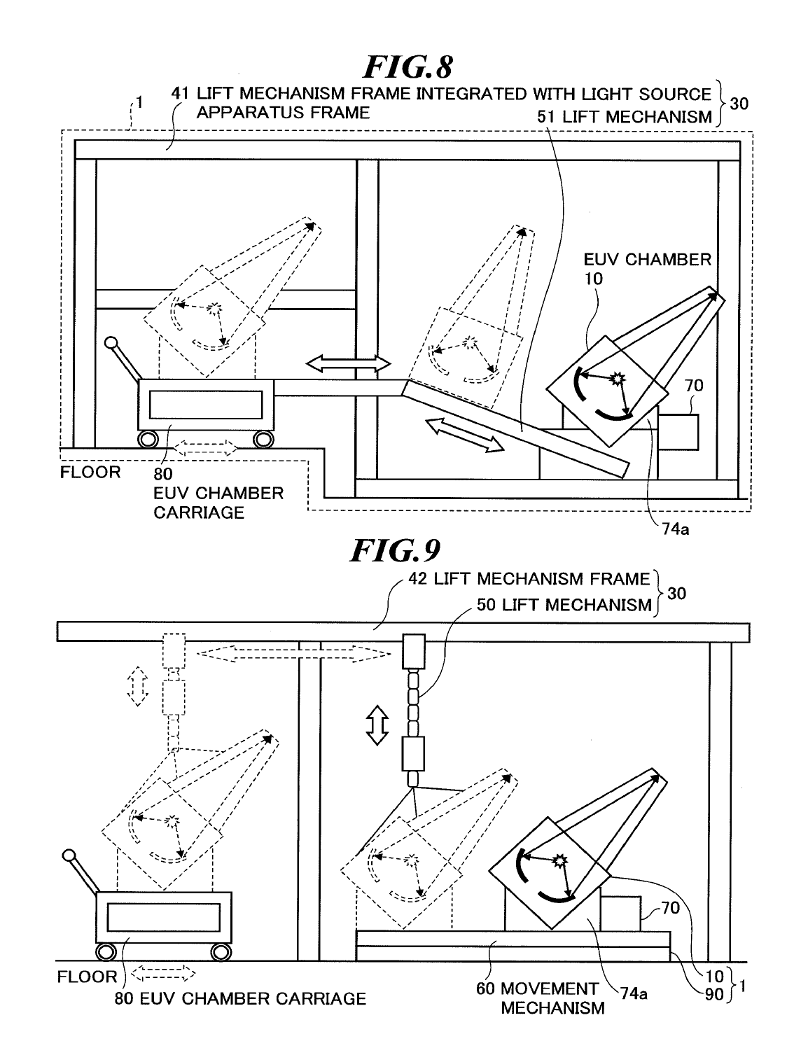

FIG. 8 is a side view showing a third example of the EUV light source system according to the first embodiment.

The third example is different from the second example in that a lift mechanism 51 lifts the replacement part along a slope. The rest of the configuration is the same as that of the second example. The lift mechanism 51 in the third example may serve as the movement mechanism 60 in the second example as shown in FIG. 7.

In the lift mechanism 51 as shown in FIG. 8, the specific configuration for lifting the replacement part along a slope is not particularly limited, but, for example, rack and pinion may be used. The rack is formed by cutting a gear on one side surface of an elongated flat plate, and the pinion is a circular gear wheel having a small diameter. The rack and pinion lifts the replacement part along a slope by fixing the rack along the slope, meshing the pinion, which is axially supported by the replacement part, with the above-described rack, and rotationally driving the pinion. Alternatively, to the contrary, the pinion may be provided on the slope and the rack may be fixed to the replacement part.

In addition, as a configuration of the lift mechanism 51 for lifting the replacement part along the slope, a configuration in which a long screw is provided in a direction along the slope, a part meshing with the screw is attached to the replacement part, and the screw is rotated may be used. Further, a configuration in which one end of a wire or the like is attached to the replacement part, the other end of the wire is pulled upward along the slope, and thereby, the replacement part is lifted may be used.

Since the third example has the above-mentioned configuration, the replacement part can be moved easily to the location at a different floor surface height as is the case of the second example in addition to the advantage of the first example.

FIG. 9 is a side view showing a fourth example of the EUV light source system according to the first embodiment.

The fourth example is different from the first example in that a lift mechanism frame 42 is separated from a frame 90 of the EUV light source apparatus 1. The rest of the configuration is the same as that of the first example. As shown in FIG. 9, the EUV light source apparatus 1 includes the frame 90 of the EUV light source apparatus in addition to the EUV chamber 10. The first example is more advantageous in the improvement of the location alignment accuracy of the lift mechanism 50, but the fourth example has an advantage in an existing light source apparatus without the lifting apparatus 30. That is, when the lifting apparatus 30 is newly provided for improvement of ease of maintenance, the lifting apparatus 30 can be provided without making any changes to the frame of the existing EUV light source apparatus 1.

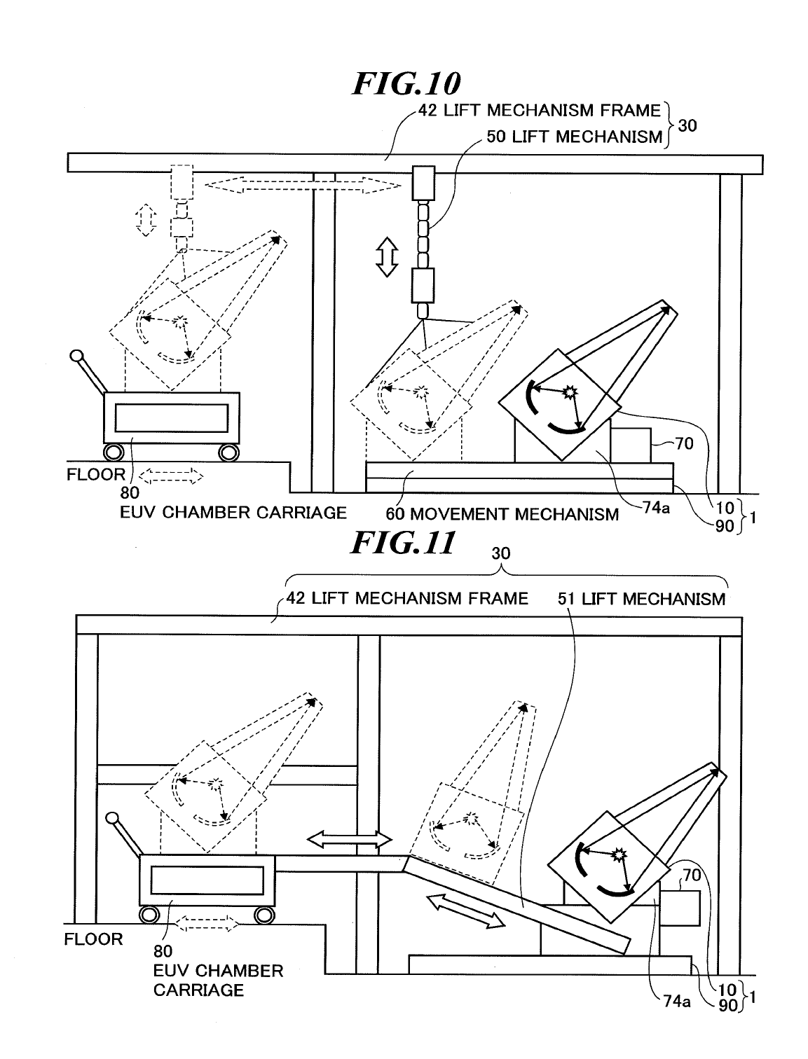

FIG. 10 is a side view showing a fifth example of the EUV light source system according to the first embodiment.

The fifth example is different from the second example in that the lift mechanism frame 42 is separated from the frame 90 of the EUV light source apparatus 1. The rest of the configuration is the same as that of the second example. The second example is more advantageous in the improvement of the location alignment accuracy of the lift mechanism 50, but the fifth example has an advantage in an existing light source apparatus without the lifting apparatus 30. That is, when the lifting apparatus 30 is newly provided for improvement of ease of maintenance, the lifting apparatus 30 can be provided without making any changes to the frame of the existing EUV light source apparatus 1.

FIG. 11 is a side view showing a sixth example of the EUV light source system according to the first embodiment.

The sixth example is different from the third example in that the lift mechanism frame 42 is separated from the frame 90 of the EUV light source apparatus 1. The rest of the configuration is the same as that of the third example. The third example is more advantageous in the improvement of the location alignment accuracy of the lift mechanism 50, but the sixth example has an advantage in an existing light source apparatus without the lifting apparatus 30. That is, when the lifting apparatus 30 with the lift mechanism 51 is newly provided for improvement of ease of maintenance, the lifting apparatus 30 can be provided without making any changes to the frame of the existing EUV light source apparatus 1.

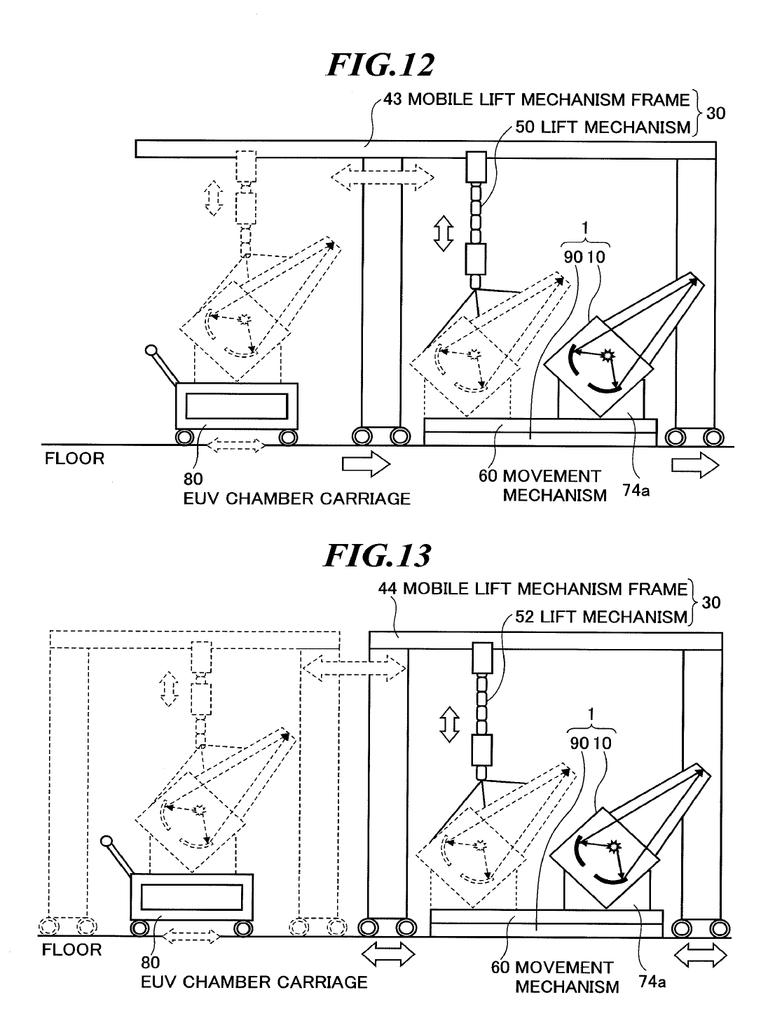

FIG. 12 is a side view showing a seventh example of the EUV light source system according to the first embodiment.

The seventh example is different from the fourth example in that a lift mechanism frame 43 is not fixed to the EUV light source apparatus 1 and the lift mechanism frame 43 is movable on the floor surface. The rest of the configuration is the same as that of the fourth example. The configuration for making the lift mechanism frame 43 movable is not particularly limited, but, for example, wheels may be attached to the ground contact surface of the lift mechanism frame 43, the wheels turn, and thereby, the lift mechanism frame 43 is movable. Further, rails on which the wheels turn may be provided on the floor surface.

The mobile lift mechanism frame 43 is placed near the EUV light source apparatus 1 in advance, and the lift mechanism frame 43 is moved to a desired location and positioned when a part such as the EUV chamber 10 is replaced. Under the condition that the lift mechanism frame 43 is positioned in the desired location, the lift mechanism 50 lifts and moves the replacement part between the movement mechanism 60 and the EUV chamber carriage 80. After the lifting and movement of the replacement part is completed, the lift mechanism frame 43 is returned to the original location near the EUV light source apparatus 1.

Since the seventh example has the above-mentioned configuration, one lifting apparatus 30 can be commonly shared in plural pieces of exposure equipment located near one another in addition to the advantage of the fourth example.

FIG. 13 is a side view showing an eighth example of the EUV light source system according to the first embodiment.

The eighth example is different from the seventh example in that a lift mechanism 52 is not movable relative to a lift mechanism frame 44. The rest of the configuration is the same as that of the seventh example. In order to move a replacement part in the eighth example, after the replacement part is lifted by the lift mechanism 52, the lift mechanism frame 44 itself is moved.

The mobile lift mechanism frame 44 is placed near the EUV light source apparatus 1 in advance, and when a part such as the EUV chamber 10 is replaced, the lift mechanism frame 44 is moved to a desired location where the lift mechanism frame 44 can support the replacement part. The movement of the replacement part between the movement mechanism 60 and the EUV chamber carriage 80 is performed by moving the lift mechanism frame 44 after the replacement part is lifted by the lift mechanism 52. After the lifting and movement of the replacement part is completed, the lift mechanism frame 44 is returned to the original location near the EUV light source apparatus 1.

Since the eighth example has the above-mentioned configuration, configuration for moving the lift mechanism 52 relative to the lift mechanism frame 44 is unnecessary, and the configuration can be simplified in addition to the advantage of the seventh example.

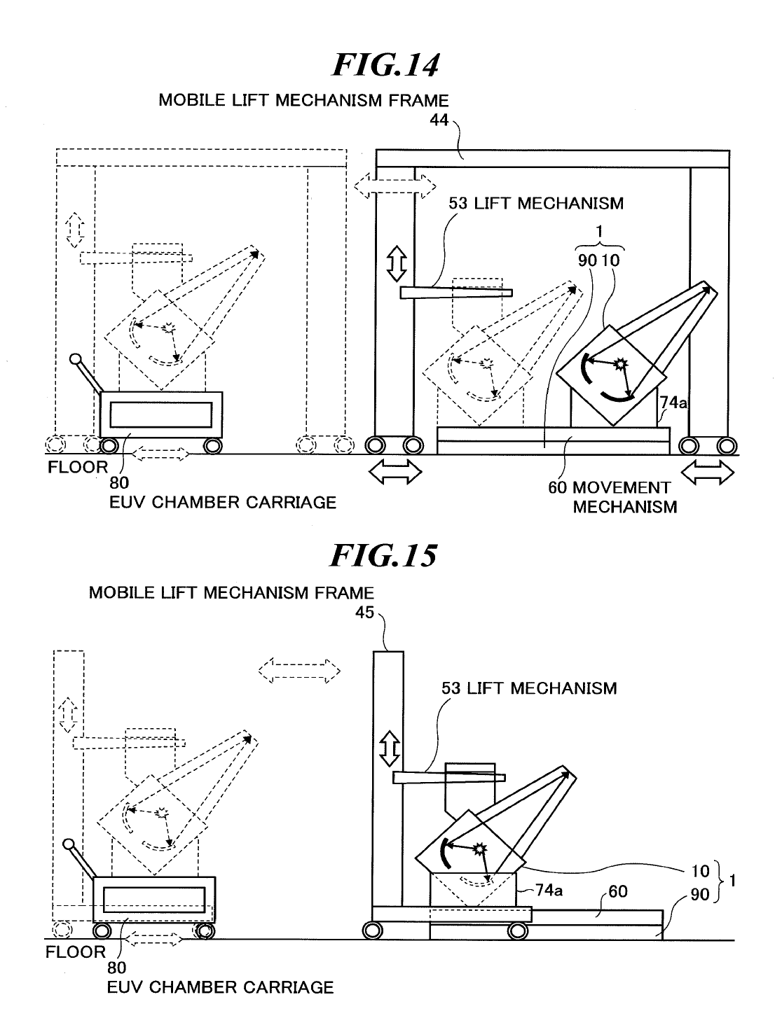

FIG. 14 is a side view showing a ninth example of the EUV light source system according to the first embodiment.

The ninth example is different from the eighth example in that a lift mechanism 53 is not provided on the beam member of the lift mechanism frame 44, but provided on a part of the column member of the lift mechanism frame 44. The rest of the configuration is the same as that of the eighth example. The lift mechanism 53 is a cantilever beam with one end supported by the column member of the lift mechanism frame 44, and vertically movable in a direction of gravity force along the column member. The lift mechanism 53 can lift a replacement part by picking up and vertically moving the replacement part like a forklift.

Since the ninth example has the above-mentioned configuration, configuration for moving the lift mechanism 53 in a direction orthogonal to the direction of gravity force relative to the lift mechanism frame 44 is unnecessary, and the configuration can be simplified as is the case of the eighth example.

FIG. 15 is a side view showing a tenth example of the EUV light source system according to the first embodiment.

The tenth example is different from the ninth example in that no beam member exists in a lift mechanism frame 45, but only the column member necessary for supporting the lift mechanism 53 is provided. The rest of the configuration is the same as that of the ninth example.

Since the tenth example has the above-mentioned configuration, the configuration of the lift mechanism frame 45 can be simplified and the lift mechanism frame 45 can be moved to a smaller space, and thereby, usability can be improved in addition to the advantage of the ninth example.

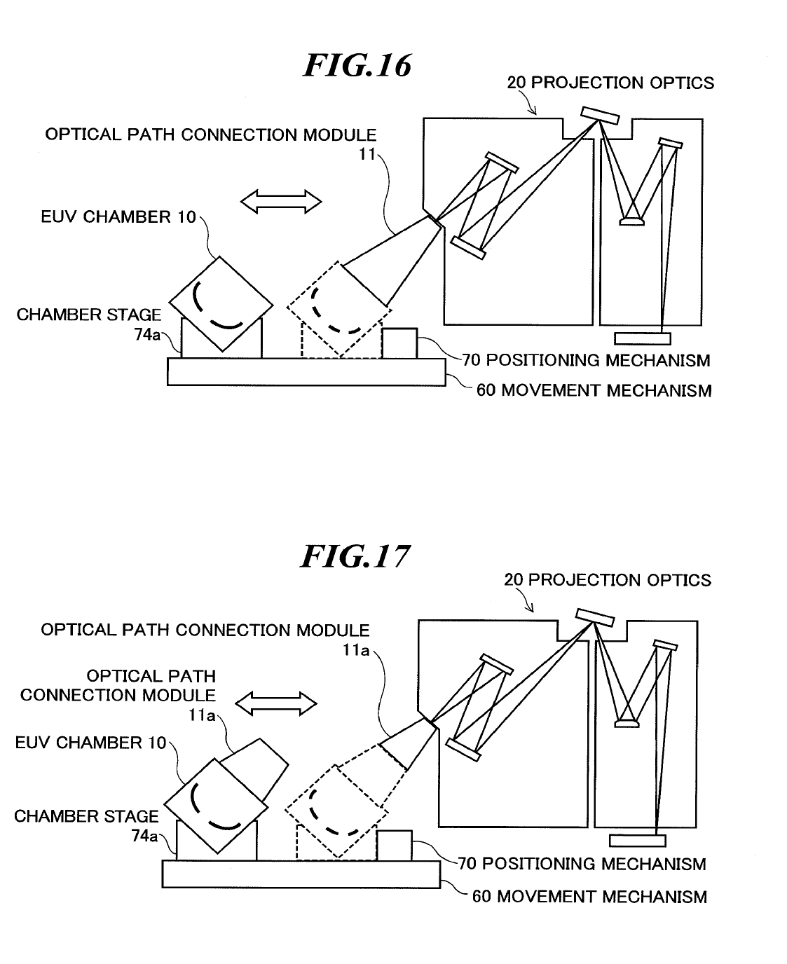

FIG. 16 is a side view showing an eleventh example of the EUV light source system according to the first embodiment. In FIG. 16, the lifting apparatus is omitted.

The eleventh example is different from the first to tenth examples in that maintenance can be performed by lifting and moving a replacement part (EUV chamber 10 or the like) other than the optical path connection module 11 by using the lifting apparatus while the optical path connection module 11 remains connected to the projection optics 20. The rest of the configuration is the same as those of the first to tenth examples.

It is desirable that the replacement part to be lifted and moved by the lifting apparatus in the eleventh example includes the target supply unit 3, the target collecting unit 5, the EUV collector mirror 15, and so on provided in the EUV chamber 10 as shown in FIG. 2. That is, the target supply unit 3 is a unit for supplying the target material into the EUV chamber 10, and requires regular replacement because clogging occurs in the target nozzle 8 or the like after a long period of use. The target collecting unit 5 is a unit for collecting the target material that has been supplied from the target supply unit 3 but not turned into plasma, and requires regular replacement because the target collecting unit 5 is getting contaminated with the target material in use. The EUV collector mirror 15 requires regular replacement because its reflectivity becomes lower due to adherent of the target material, ion etching, or the like in use.

On the other hand, the optical path connection module 11 requires less frequent maintenance than the target supply unit 3, the target collecting unit 5, and the EUV collector mirror 15 provided in the EUV chamber 10. Accordingly, in the eleventh example, the EUV chamber 10 is separated from the optical path connection module 11 so as to be carried to the maintenance area.

In the eleventh example as shown in FIG. 16, a gate valve or lid may be provided in a connecting part between the EUV chamber 10 and the optical path connection module 11 such that air may not enter the EUV chamber 10 or the optical path connection module 11. Further, before the EUV chamber 10 and the optical path connection module 11 are separated, the EUV chamber 10 and the optical path connection module 11 may be filled with an inert gas such as nitrogen gas or argon gas to near the atmospheric pressure.

In the eleventh example, the EUV chamber 10 and the optical path connection module 11 are separated, but the EUV chamber 10 may be divided and only a part of the EUV chamber 10 may be lifted by the lifting apparatus and moved.

FIG. 17 is a side view showing a twelfth example of the EUV light source system according to the first embodiment. In FIG. 17, the lifting apparatus is omitted.

In the twelfth example, the EUV chamber 10 and the projection optics 20 are connected by connecting an optical path connection module 11a connected to the EUV chamber 10 and an optical path connection module 11b connected to the projection optics 20 to each other. The twelfth example is different from the eleventh example in that maintenance can be performed by lifting and moving the optical path connection module 11a and the EUV chamber 10 by using the lifting apparatus while the optical path connection module 11b remains connected to the projection optics 20. The rest of the configuration is the same as that of the eleventh example.

In the twelfth example, a gate valve or lid may be provided in a connecting part between the optical path connection module 11a and the optical path connection module lib such that air may not enter the optical path connection module 11a and the optical path connection module 11b.

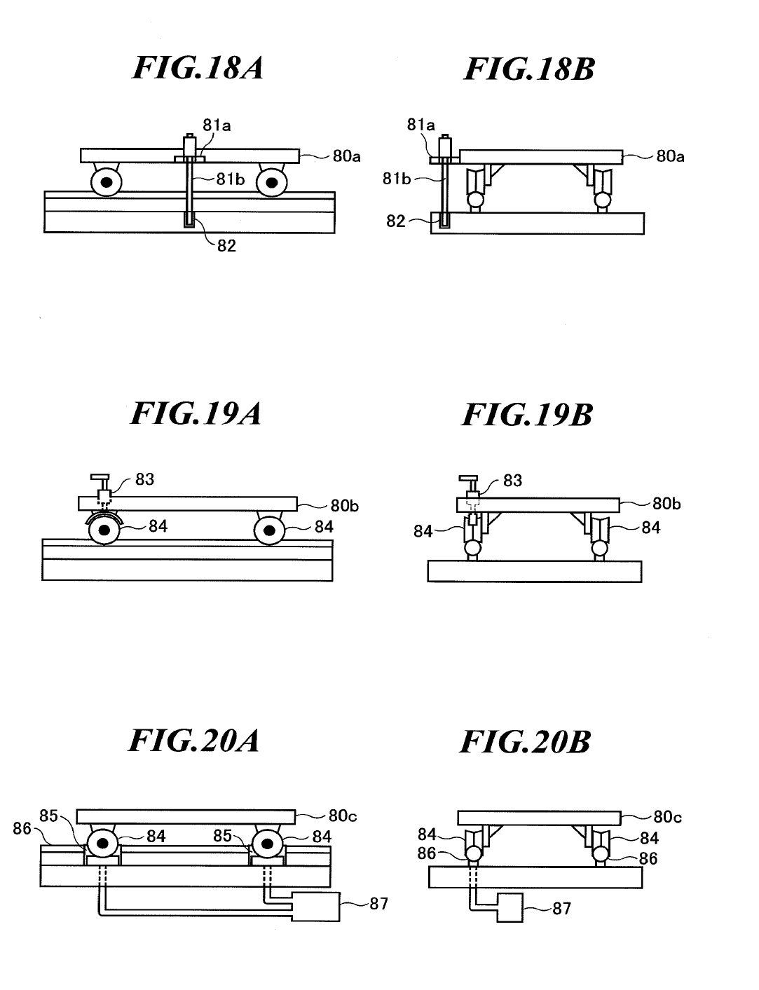

FIGS. 18A and 18B are a side view and a front view showing a thirteenth example relating to an EUV chamber carriage in the first embodiment. In FIGS. 18A and 18B, the EUV light source apparatus and the lifting apparatus are omitted.

The thirteenth example is different from the first to twelfth examples in that a fixation mechanism for fixing an EUV chamber carriage 80a to a desired location. The rest of the configuration regarding the EUV light source apparatus, the projection optics, and the lifting apparatus, for example, may employ the same configuration as those of the first to twelfth examples.

The EUV chamber carriage 80a in the thirteenth example has a pin 81b supported to be vertically movable by a pin supporting part 81a projecting laterally relative to the traveling direction of the EUV chamber carriage 80a. When the lower end of the pin 81b is inserted into a hole 82 formed in the floor surface, the position of the EUV chamber carriage 80a is fixed. By withdrawing the pin 81b from the hole 82, the EUV chamber carriage 80a can be moved.

In FIGS. 18A and 18B, the pin supporting part 81a projects laterally relative to the traveling direction of the EUV chamber carriage 80a, and therefore, the pin 81b and the hole 82 are located laterally relative to the traveling direction of the EUV chamber carriage 80a. However, the present invention is not limited to the location. The pin supporting part 81a may project forward or backward relative to the traveling direction of the EUV chamber carriage 80a, and the pin 81b and the hole 82 may be located forward or backward relative to the fixed position of the EUV chamber carriage 80a. Further, the projection in the horizontal direction may be eliminated by forming the pin supporting part 81a within the EUV chamber mounting surface of the EUV chamber carriage 80a without projection in the horizontal direction. In the case where the pin supporting part 81a is formed within the EUV chamber mounting surface of the EUV chamber carriage 80a, it is desirable that the pin supporting part 81a is formed in a location that does not interfere with the mounting and movement of the EUV chamber 10.

According to the thirteenth example, since the position of the EUV chamber carriage 80a can be temporarily fixed, the work of mounting and maintenance of the replacement part in the fixed position of the EUV chamber carriage 80a can be performed in safety.

Further, as in the second example that has been explained by referring to FIG. 7, for example, in the case where the floor surface (lower floor surface) in the location where the optical axis of the EUV chamber 10 is aligned with the optical axis of the projection optics 20 is lower than the floor surface (higher floor surface) in the region where the EUV chamber 10 can be transported by the EUV chamber carriage, by adopting the EUV chamber carriage 80a as shown in FIGS. 18A and 18B, the EUV chamber carriage 80a traveling on the higher floor surface can be prevented from dropping on the lower floor surface.

FIGS. 19A and 19B are a side view and a front view showing a fourteenth example relating to the EUV chamber carriage in the first embodiment. In FIGS. 19A and 19B, the EUV light source apparatus and the lifting apparatus are omitted.

The fourteenth example is different from the thirteenth example in that a brake mechanism 83 for restricting rotation of wheels of an EUV chamber carriage 80b by friction is provided as a fixation mechanism. The rest of the configuration is the same as that of the thirteenth example.

In the EUV chamber carriage 80b in the fourteenth example, when the brake mechanism 83 is pressed against the periphery of at least one of wheels 84, the movement of the EUV chamber carriage 80b is restricted. When the brake mechanism 83 is detached from the wheel 84, the EUV chamber carriage 80b can be moved. The brake mechanism 83 may be used not only for fixing the position of the EUV chamber carriage 80b but also for decelerating the EUV chamber carriage 80b. Further, plural brake mechanisms 83 may be provided and those may be pressed against the wheels 84 at the same time.

FIGS. 20A and 20B are a side view and a front view showing a fifteenth example relating to the EUV chamber carriage in the first embodiment. In FIGS. 20A and 20B, the EUV light source apparatus and the lifting apparatus are omitted.

The fifteenth example is different from the thirteenth and fourteenth examples in that recesses 85 can be formed on the traveling route of wheels 84 of an EUV chamber carriage 80c as a fixation mechanism. The rest of the configuration is the same as those of the thirteenth and fourteenth examples.

In the fifteenth example, for example, rails 86 form the traveling route of the wheels 84. Portions of the rails 86 can be raised and lowered by oil pressure by using a hydraulic pump 87 or the like. Thereby, when the portions of the rails 86 are lowered, the recesses 85 are formed and the position of the EUV chamber carriage 80c can be fixed. By raising the portions corresponding to the recesses 85 of the rails 86, the EUV chamber carriage 80c can be moved.

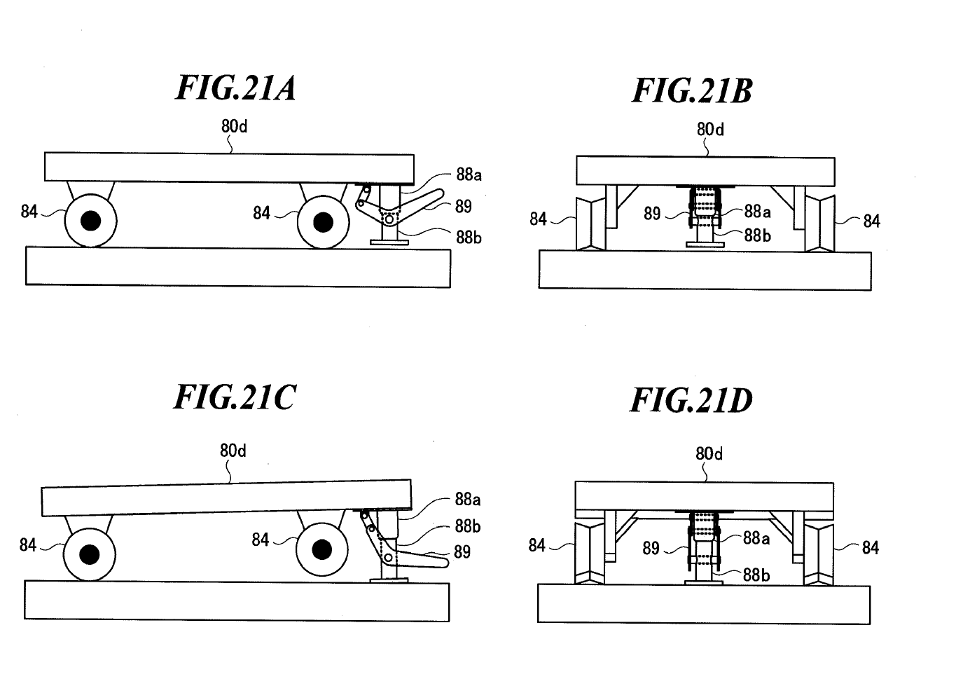

FIGS. 21A and 21C are side views showing a sixteenth example relating to an EUV chamber carriage in the first embodiment, and FIGS. 21B and 21D are front views showing the sixteenth example relating to the EUV chamber carriage in the first embodiment. FIGS. 21A and 21B show a state in which the position of an EUV chamber carriage 80d is not fixed, and FIGS. 21C and 21D show a state in which the position of the EUV chamber carriage 80d is fixed. In FIGS. 21A-21D, the EUV light source apparatus and the lifting apparatus are omitted.

The sixteenth example is different from the thirteenth to fifteenth examples in that a link mechanism including a large-diameter cylindrical part 88a, a small-diameter cylindrical part 88b, and a lever 89 is provided as a fixation mechanism. The rest of the configuration is the same as those of the thirteenth to fifteenth examples. One end of the large-diameter cylindrical part 88a is fixed to the EUV chamber carriage 80d. The small-diameter cylindrical part 88b is inserted into the other end of the large-diameter cylindrical part 88a, and the small-diameter cylindrical part 88b can go up and down within the large-diameter cylindrical part 88a. The lever 89 determines the insertion depth of the small-diameter cylindrical part 88b into the large-diameter cylindrical part 88a.

As shown in FIGS. 21A and 21B, in the state in which the small-diameter cylindrical part 88b is deeply inserted into the large-diameter cylindrical part 88a and the small-diameter cylindrical part 88b floats from the floor surface, the EUV chamber carriage 80d is not fixed to the floor surface but movable. On the other hand, as shown in FIGS. 21C and 21D, by rotating the lever 89, the small-diameter cylindrical part 88b is pulled out from the large-diameter cylindrical part 88a. Thereby, the small-diameter cylindrical part 88b presses the floor surface, and at least one wheel 84 floats from the floor surface, and thereby, the position of the EUV chamber carriage 80d is fixed. As the fixation mechanism, commercially available one may be used.

Next, the second embodiment of the present invention will be explained.

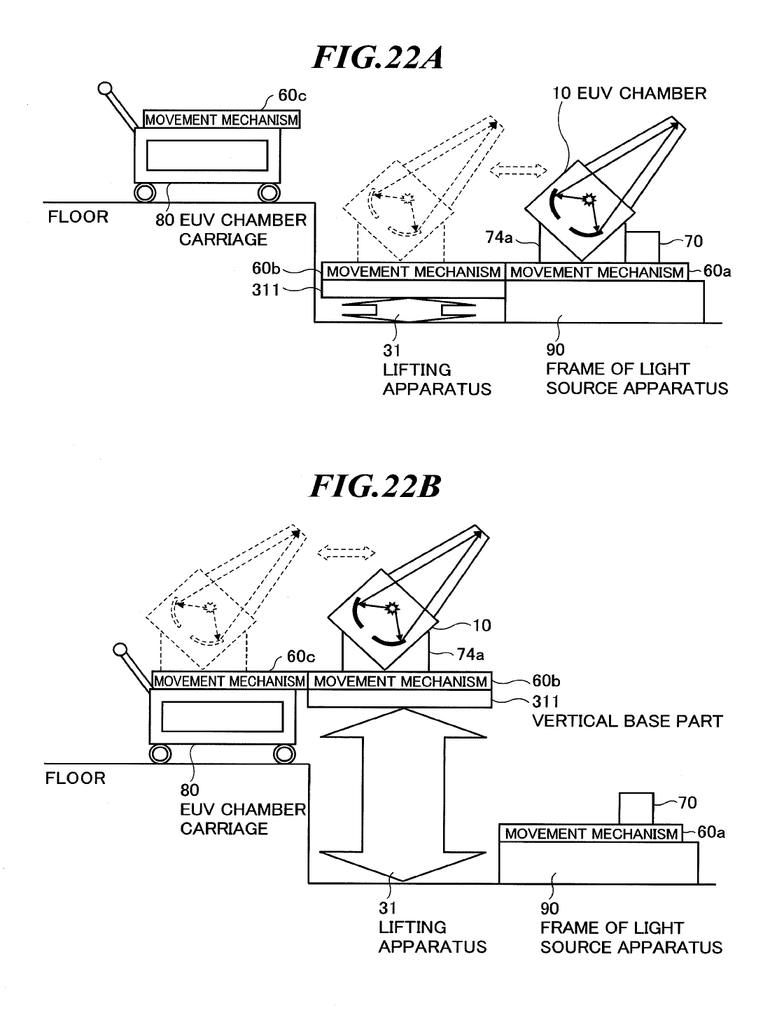

FIGS. 22A and 22B are side views showing a schematic configuration of an extreme ultraviolet (EUV) light source system according to the second embodiment of the present invention. The second embodiment is different from the first embodiment in that a lifting apparatus 31 has no lift mechanism frame. The rest of the configuration is the same as that of the first embodiment. For example, as explained by referring to FIGS. 16 and 17, the replacement part or parts to be lifted and moved by the lifting apparatus may include a part or whole of the EUV chamber 10 or a part or whole of the optical path connection module 11 in addition to the EUV chamber 10. Further, as explained by referring to FIGS. 18A-20B, the EUV chamber carriage may be fixed in a desired position by the fixation mechanism.

As shown in FIGS. 22A and 22B, a frame 90 of the EUV light source apparatus is fixed to the lower floor surface where the EUV chamber 10 is placed, and a movement mechanism 60a and a positioning mechanism 70 are fixed onto the frame 90 of the EUV light source apparatus. When the EUV chamber is positioned on the movement mechanism 60a by the positioning mechanism 70, the optical axis of the EUV chamber 10 is aligned with the optical axis of the projection optics 20.

Further, the lifting apparatus 31 is placed on the lower floor surface. The lifting apparatus 31 has a mechanism for vertically moving a vertical base part 311 for supporting the replacement part such as the EUV chamber 10 from below by using a link mechanism, a lead screw, a fluid pressure cylinder, an accordion tube, or the like. The details of the mechanism for vertically moving the vertical base part 311 will be described later. A movement mechanism 60b is fixed onto the vertical base part 311. When the vertical base part 311 is located in the lower position as shown in FIG. 22A, the EUV chamber 10 can make a round trip between the movement mechanism 60a on the frame 90 of the EUV light source apparatus and the movement mechanism 60b on the vertical base part 311.

On the higher floor surface, the EUV chamber carriage 80 can travel. A movement mechanism 60c is fixed on the EUV chamber carriage 80. When the vertical base part 311 is located in the upper position as shown in FIG. 22B and the EUV chamber carriage 80 waits adjacent to the lifting apparatus 31, the EUV chamber 10 can make a round trip between the movement mechanism 60b on the vertical base part 311 and the movement mechanism 60c on the EUV chamber carriage 80.

In this manner, in the second embodiment, the movement of the replacement part such as the EUV chamber 10 on the lower floor surface is performed between the movement mechanism 60a and the movement mechanism 60b, and the movement from the region of the lower floor surface to the region of the higher floor surface is performed between the movement mechanism 60b and the movement mechanism 60c, and the movement within the region of the higher floor surface is performed by the EUV chamber carriage 80.

The configurations of the movement mechanisms 60a-60c are not particularly limited, but, for example, rails on which the chamber stage 74a can travel may be used as the movement mechanisms 60a-60c.

According to the second embodiment, configuration for hoisting the replacement part such as the EUV chamber 10 by using a crane or the like is unnecessary, and structure such as a frame higher than the lifting height of the replacement part is unnecessary for the lifting apparatus 31, and thereby, the installation space of the EUV light source system can be reduced.

Next, specific examples of the EUV light source system according to the above-mentioned second embodiment will be explained. The explanation of the above-mentioned second embodiment applies to the following respective examples without change unless it goes against their nature.

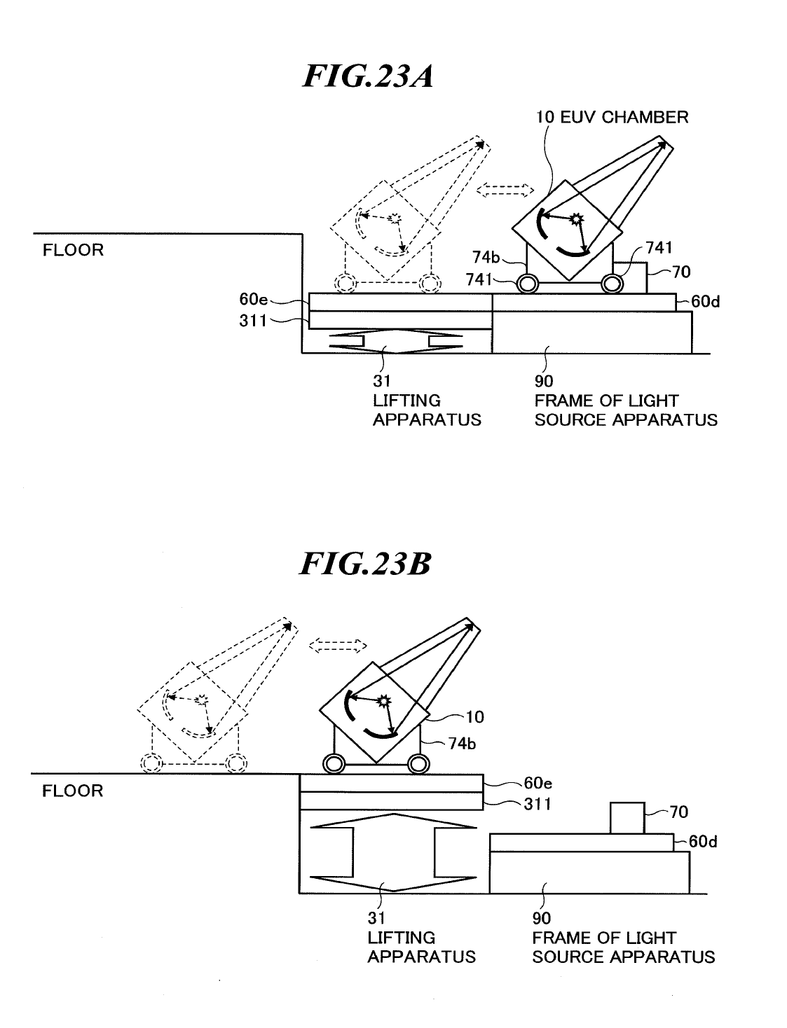

FIGS. 23A and 23B are side views showing the sixteenth example relating to the movement mechanism in the EUV light source system according to the second embodiment.

The sixteenth example as shown in FIGS. 23A and 23B is provided with wheels as a movement mechanism in a chamber stage and a base with no movement mechanism in place of the movement mechanisms 60a-60c in the second example as shown in FIGS. 22A and 22B. In FIGS. 23A and 23B, the chamber stage 74b is made movable on a base 60d on the frame 90 of the EUV light source apparatus, a base 60e on the vertical base part 311, and the higher floor surface by wheels 741.

According to the sixteenth example, since the chamber stage 74b has the wheels 741, the chamber stage 74b can be moved smoothly to a desired position.

In the sixteenth example as shown in FIGS. 23A and 23B, the case where the EUV chamber 10 is mounted on the chamber stage 74b having the wheels 741 has been explained, but the form for moving the replacement part by using the wheels is not limited to that. For example, the chamber stage 74a with no wheels may be mounted on the EUV chamber carriage 80 having wheels as explained by referring to FIGS. 6-15. Further, the replacement part such as the EUV chamber 10 itself may have a movable mechanism such as wheels (e.g., casters) to be movable. Furthermore, a guide mechanism for guiding the movement direction of the wheels (e.g., casters) may be provided on the bases 60d and 60e in FIGS. 23A and 23B.

Alternatively, the fixation mechanisms of the EUV chamber carriages 80a-80c with wheels as explained by referring to FIGS. 18A-20B may be applied to fixation of the chamber stage 74b with wheels in FIGS. 23A and 23B. The chamber stage 74b can be temporarily fixed on the base 60e by using the fixation mechanism, and thereby, raising and lowering operation of the replacement part by using the lifting apparatus 31 can be performed in safety.

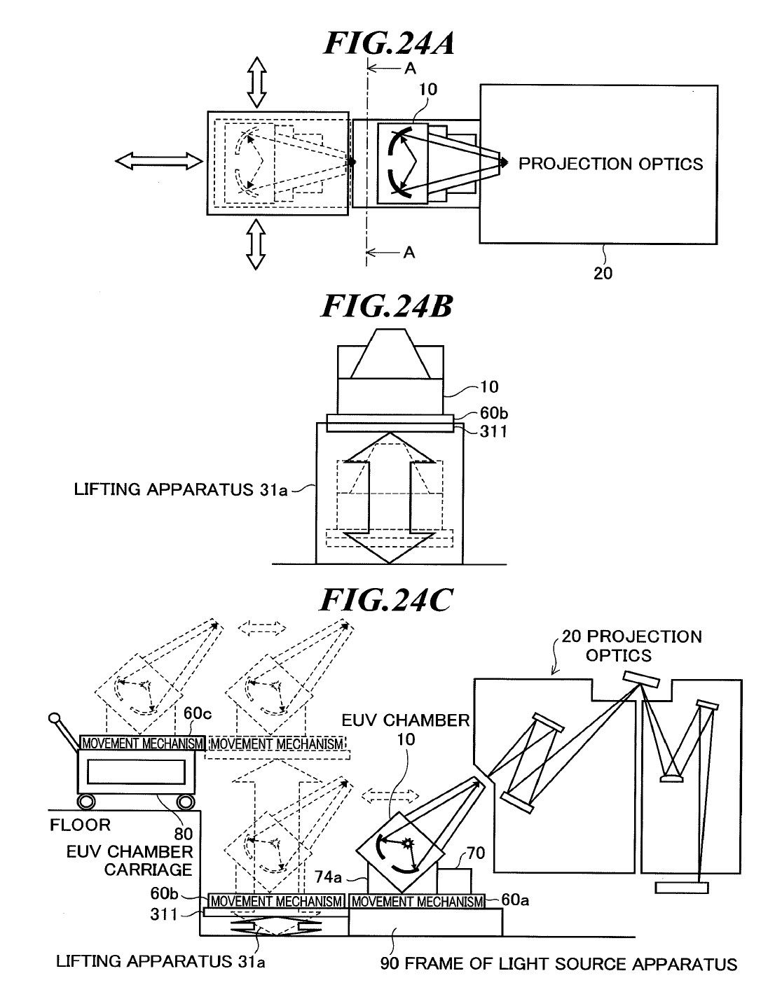

FIGS. 24A-24C are a plan view showing a seventeenth example of the EUV light source system according to the second embodiment, a sectional view along A-A line in FIG. 24A, and a side view.

The seventeenth example as shown in FIGS. 24A-24C is provided with a lifting apparatus beneath the vertical base part 311 in the second embodiment as shown in FIGS. 22A and 22B.

According to the seventeenth example as shown in FIGS. 24A-24C, since the lifting apparatus 31a is provided beneath the vertical base part 311, the installation floor area of the EUV light source system including the lifting apparatus 31a and the vertical base part 311 can be reduced.

The movement direction, in which the replacement part is moved from the vertical base part 311 lifted together with the replacement part by the lifting apparatus 31a to the EUV chamber carriage 80 on the higher floor surface, may be a direction in parallel to the direction toward the projection optics 20 or a direction orthogonal to the direction toward the projection optics 20, as shown by two-headed arrows in FIG. 24A.

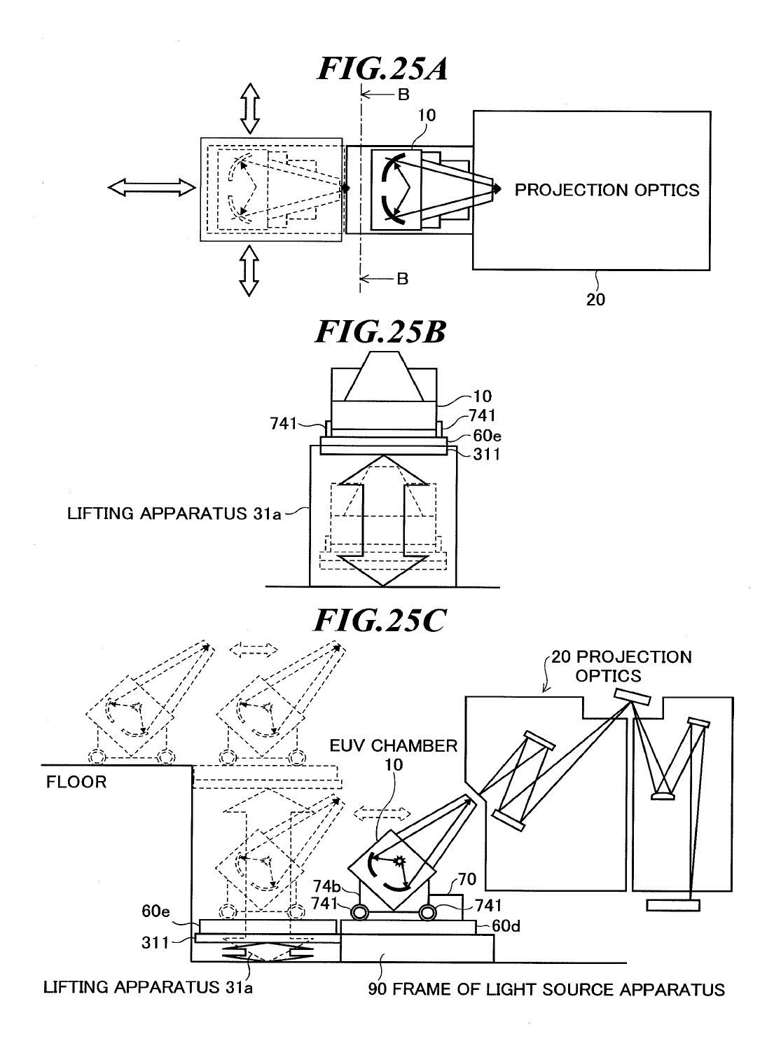

FIGS. 25A-25C are a plan view showing an eighteenth example of the EUV light source system according to the second embodiment, a sectional view along B-B line in FIG. 25A, and a side view.

The eighteenth example as shown in FIGS. 25A-25C is different from the seventeenth example as shown in FIGS. 24A-24C in that the chamber stage 74b is provided with the wheels 741 as the movement mechanism and bases 60d and 60e with no movement mechanism are provided in place of the movement mechanisms 60a-60c. The rest of the configuration is the same as that of the seventeenth example. In FIGS. 25A-25C, the chamber stage 74b is made movable on the base 60d on the frame 90 of the EUV light source apparatus, the base 60e on the vertical base part 311, and the higher floor surface by the wheels 741.

According to the eighteenth example, since the chamber stage 74b has the wheels 741, the chamber stage 74b can be moved smoothly to a desired position.

In the eighteenth example as shown in FIGS. 25A-25C, the case where the EUV chamber 10 is mounted on the chamber stage 74b having the wheels 741 has been explained, but the form for moving the replacement part by using the wheels is not limited to that. For example, the chamber stage 74b with no wheels may be mounted on the EUV chamber carriage 80 having wheels as explained by referring to FIGS. 6-15. Further, the replacement part such as the EUV chamber 10 itself may have a movable mechanism such as wheels (e.g., casters) to be movable. Furthermore, a guide mechanism for guiding the movement direction of the wheels (e.g., casters) may be provided on the bases 60d and 60e in FIGS. 25A-25C.

Alternatively, the fixation mechanisms of the EUV chamber carriages 80a-80c with wheels as explained by referring to FIGS. 18A-20B may be applied to fixation of the chamber stage 74b with wheels in FIGS. 25A-25C. The chamber stage 74b can be temporarily fixed on the base 60e by using the fixation mechanism, and thereby, raising and lowering operation of the replacement part by the lifting apparatus 31a can be performed in safety.

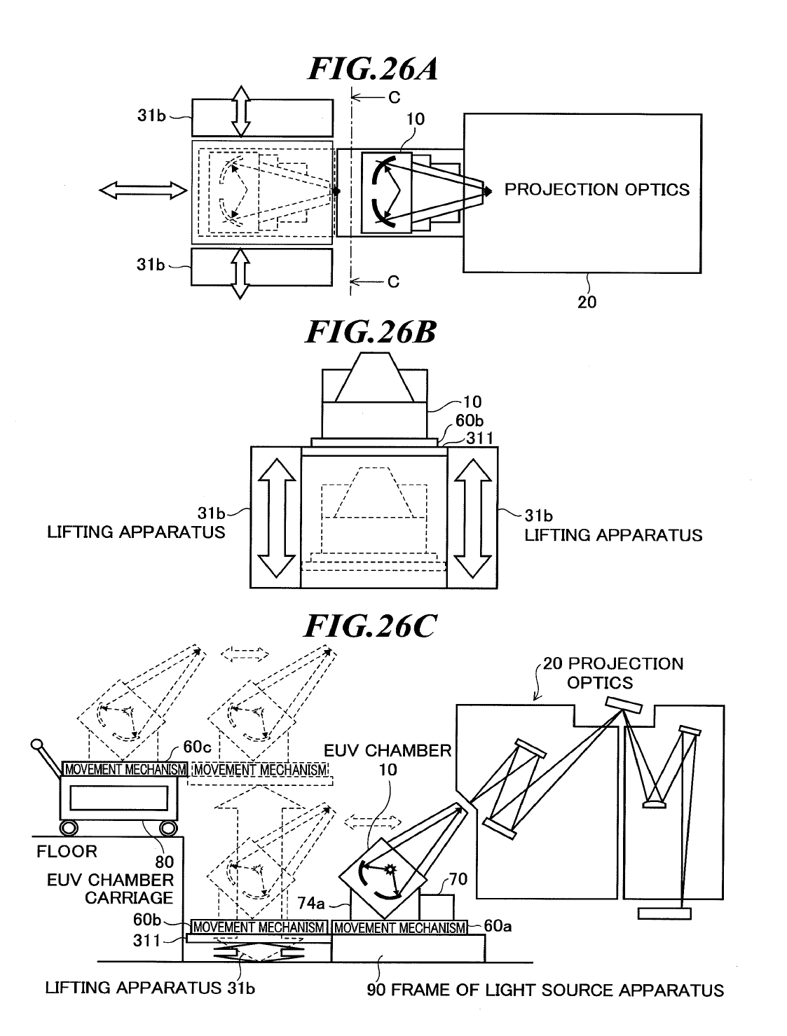

FIGS. 26A-26C are a plan view showing a nineteenth example of the EUV light source system according to the second embodiment, a sectional view along C-C line in FIG. 26A, and a side view.

The nineteenth example as shown in FIGS. 26A-26C is provided with lifting apparatuses at both sides of the vertical base part 311 in the second embodiment as shown in FIGS. 22A and 22B.

According to the nineteenth example as shown in FIGS. 26A-26C, since the lifting apparatuses 31b are provided at both sides of the vertical base part 311, the installation space for the lifting apparatus 31b beneath the vertical base part 311 becomes unnecessary, and the movable range of the vertical base part 311 can be made larger.

The movement direction, in which the replacement part is moved from the vertical base part 311 lifted together with the replacement part by the lifting apparatuses 31b to the EUV chamber carriage 80 on the higher floor surface, may be a direction in parallel to the direction toward the projection optics 20 or a direction orthogonal to the direction toward the projection optics 20, as shown by two-headed arrows in FIG. 26A. In FIGS. 26A-26C, although the example in which the lifting apparatuses 31b are provided at both sides of the vertical base part 311 has been shown, the present invention is not limited to the example, but the lifting apparatus 31b may be provided at one side only.

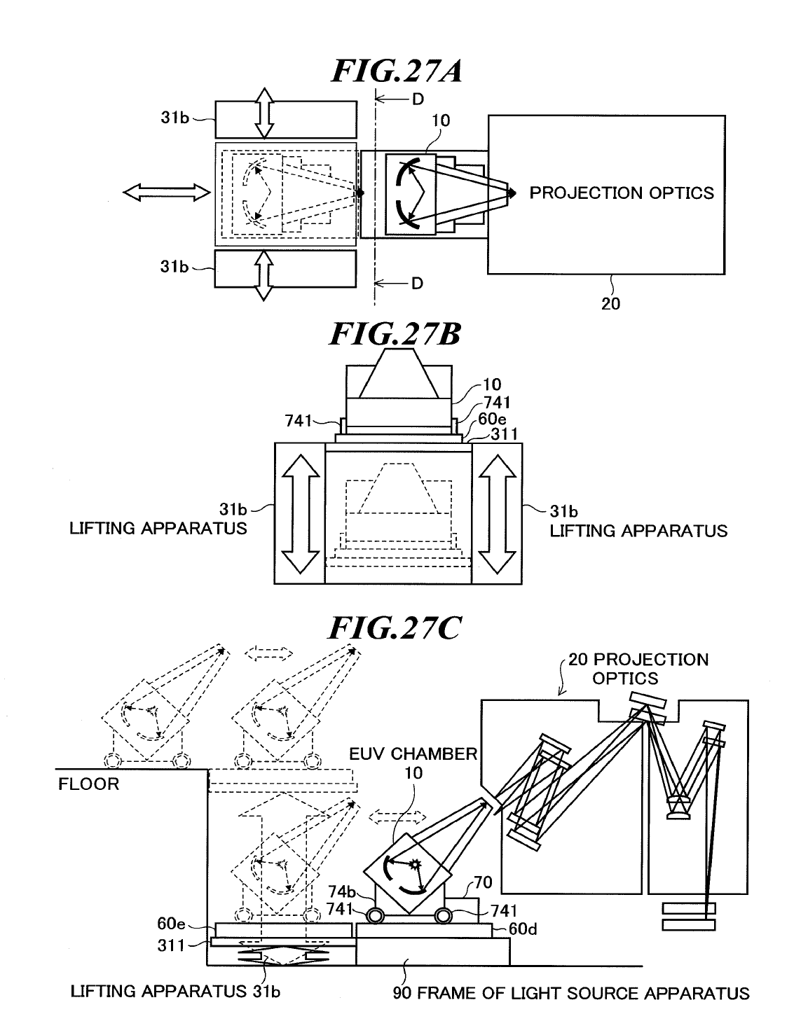

FIGS. 27A-27C are a plan view showing a twentieth example of the EUV light source system according to the second embodiment, a sectional view along D-D line in FIG. 27A, and a side view.

The twentieth example as shown in FIGS. 27A-27C is different from the nineteenth example as shown in FIGS. 26A-26C in that the chamber stage 74b is provided with the wheels 741 as the movement mechanism and bases 60d and 60e with no movement mechanism are provided in place of the movement mechanisms 60a-60c. The rest of the configuration is the same as that of the nineteenth example. In FIGS. 27A-27C, the chamber stage 74b is made movable on the base 60d on the frame 90 of the EUV light source apparatus, the base 60e on the vertical base part 311, and the higher floor surface by the wheels 741.

According to the twentieth example, since the chamber stage 74b has the wheels 741, the chamber stage 74b can be moved smoothly to a desired position.

In the twentieth example as shown in FIGS. 27A-27C, the case where the EUV chamber 10 is mounted on the chamber stage 74b having the wheels 741 has been explained, but the form for moving the replacement part by using the wheels is not limited to that. For example, the chamber stage 74b with no wheels may be mounted on the EUV chamber carriage 80 having wheels as explained by referring to FIGS. 6-15. Further, the replacement part such as the EUV chamber 10 itself may have a movable mechanism such as wheels (e.g., casters) to be movable. Furthermore, a guide mechanism for guiding the movement direction of the wheels (e.g., casters) may be provided on the bases 60d and 60e in FIGS. 27A-27C.

Alternatively, the fixation mechanisms of the EUV chamber carriages 80a-80c with wheels as explained by referring to FIGS. 18A-20B may be applied to fixation of the chamber stage 74b with wheels in FIGS. 27A-27C. The chamber stage 74b can be temporarily fixed on the base 60e by using the fixation mechanism, and thereby, raising and lowering operation of the replacement part by the lifting apparatus 31b can be performed in safety.

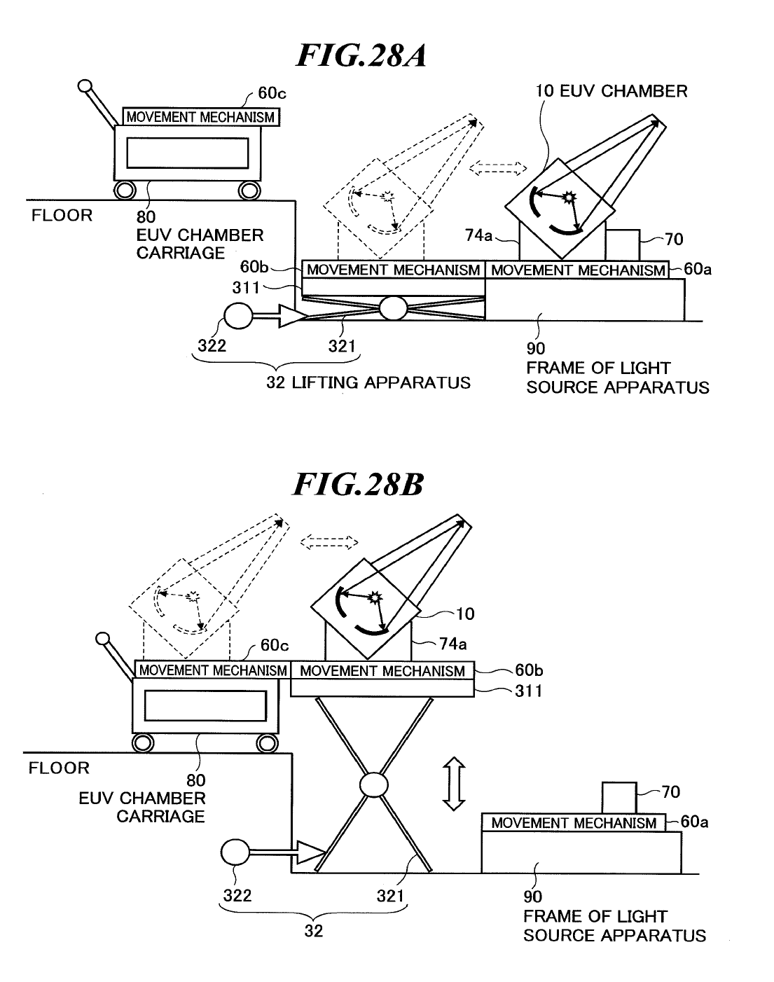

FIGS. 28A and 28B are side views showing a twenty-first example of the EUV light source system according to the second embodiment.

The twenty-first example as shown in FIGS. 28A and 28B is provided with a configuration of a link-mechanism type lifting apparatus 32 including an X-shaped jack 321 and a driving part 322 for driving the jack 321 to change dimensions in the horizontal direction in the second embodiment. In the lifting apparatus 32, as the driving part 322 expands and contracts, the dimensions in the horizontal direction of the X-shaped jack 321 change, and the jack 321 expands and contracts in the vertical direction, and thereby, the vertical base part 311 is raised and lowered.

The lifting apparatus 32 in FIGS. 28A and 28B may be provided beneath the vertical base part 311 as the lifting apparatus 31a as shown in FIGS. 24A-24C, or may be provided at both sides of the vertical base part 311 as the lifting apparatus 31b as shown in FIGS. 26A-26C. Further, the chamber stage 74a in FIGS. 28A and 28B may be replaced with the chamber stage 74b with the wheels 741 as shown in FIGS. 23A and 23B, FIGS. 25A-25C, and FIGS. 27A-27C.

Alternatively, in FIGS. 28A and 28B, in the case where it is necessary to make the stroke of the vertical movement by the lifting apparatus 32 larger, a combination of plural X-shaped jacks may be used.

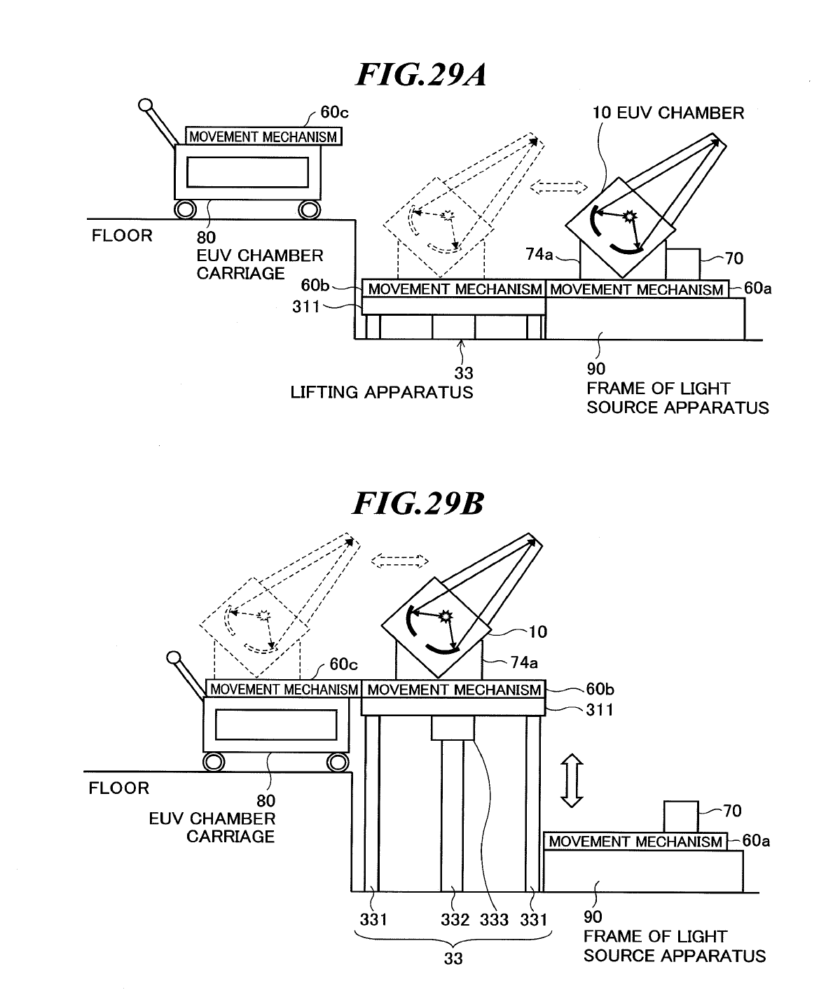

FIGS. 29A and 29B are side views showing a twenty-second example of the EUV light source system according to the second embodiment.

The twenty-second example as shown in FIGS. 29A and 29B is provided with a configuration of a lead-screw type lifting apparatus 33 including guide bars 331, a lead screw 332, and a driving part 333 for rotationally driving the lead screw 332 in the second embodiment. The lead screw 332 is screwed into the floor surface. In the lifting apparatus 33, the driving part 333 rotationally drives the lead screw 332, and thereby, the position in the axial direction of the lead screw 332 relative to the floor surface changes and the vertical base part 311 is raised and lowered. The lead screw 332 may be a ball screw, a square thread, or a trapezoidal screw thread.

The lifting apparatus 33 in FIGS. 29A and 29B may be provided beneath the vertical base part 311 as the lifting apparatus 31a as shown in FIGS. 24A-24C, or may be provided at both sides of the vertical base part 311 as the lifting apparatus 31b as shown in FIGS. 26A-26C. Further, the chamber stage 74a in FIGS. 29A and 298 may be replaced with the chamber stage 74b with the wheels 741 as shown in FIGS. 23A and 23B, FIGS. 25A-25C, and FIGS. 27A-27C.

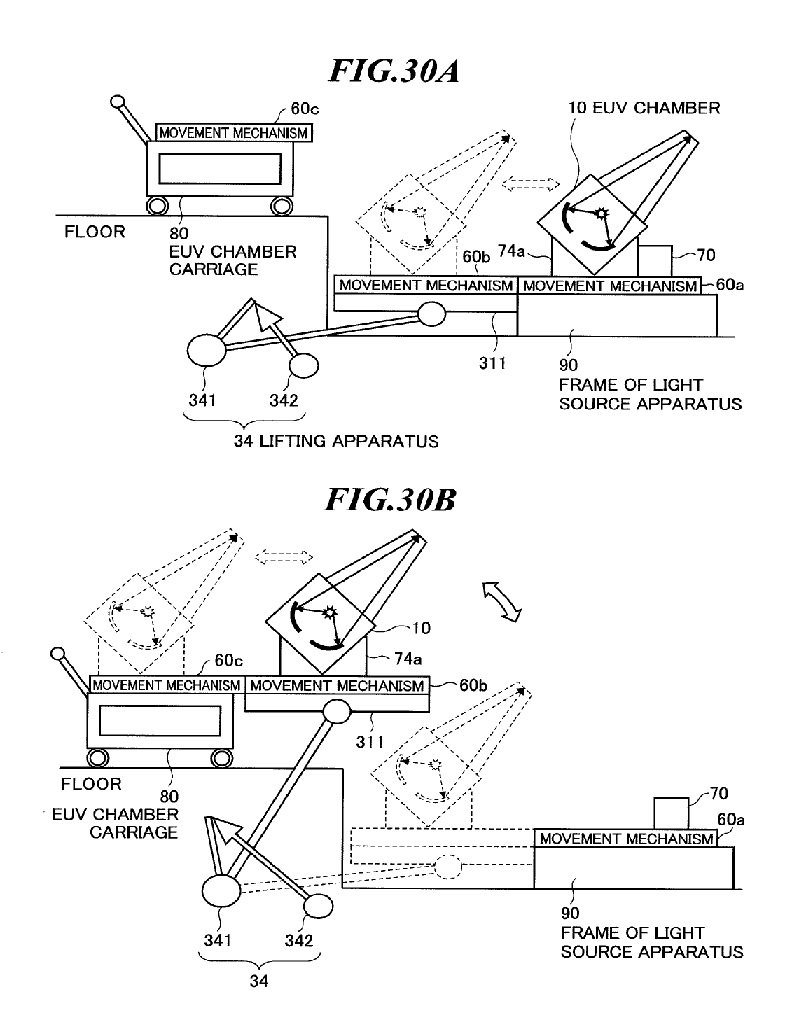

FIGS. 30A and 30B are side views showing a twenty-third example of the EUV light source system according to the second embodiment.

The twenty-third example as shown in FIGS. 30A and 30B is provided with a configuration of a link-mechanism type lifting apparatus 34 including a lever 341 and a driving part 342 for rotationally driving the lever 341. In the lifting apparatus 34, the driving part 342 rotationally drives the lever 341, and thereby, the lever 341 that supports the vertical base part 311 changes from the nearly horizontal position (FIG. 30A) to the nearly vertical position (FIG. 30B), and thereby, the vertical base part 311 is raised and lowered.

The lifting apparatus 34 in FIGS. 30A and 30B may be provided beneath the vertical base part 311 as the lifting apparatus 31a as shown in FIGS. 24A-24C, or may be provided at both sides of the vertical base part 311 as the lifting apparatus 31b as shown in FIGS. 26A-26C. Further, the chamber stage 74a in FIGS. 30A and 30B may be replaced with the chamber stage 74b with the wheels 741 as shown in FIGS. 23A and 23B, FIGS. 25A-25C, and FIGS. 27A-27C.

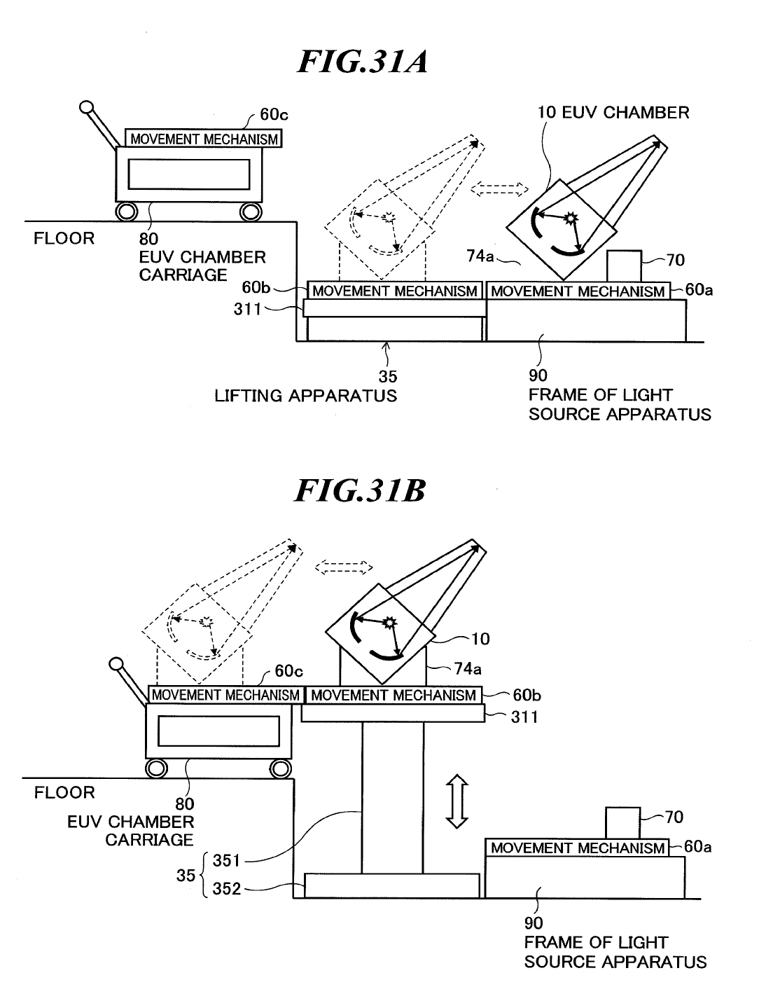

FIGS. 31A and 31B are side views showing a twenty-fourth example of the EUV light source system according to the second embodiment.

The twenty-fourth example as shown in FIGS. 31A and 31B is provided with a lifting apparatus 35 including a cylinder rod 351 and a pump 352 for driving the cylinder rod 351 with fluid pressure of oil pressure, air pressure, or the like in the second embodiment. In the lifting apparatus 35, the pump 352 supplies a fluid into the cylinder rod 351 or discharges the fluid from the cylinder rod 351, and thereby, the vertical base part 311 is raised and lowered. In the example, as the fluid, for example, a gas such as clean air or nitrogen gas, or a liquid such as oil may be used.

The lifting apparatus 35 in FIGS. 31A and 31B may be provided beneath the vertical base part 311 as the lifting apparatus 31a as shown in FIGS. 24A-24C, or may be provided at both sides of the vertical base part 311 as the lifting apparatus 31b as shown in FIGS. 26A-26C. Further, the chamber stage 74a in FIGS. 31A and 31B may be replaced with the chamber stage 74b with the wheels 741 as shown in FIGS. 23A and 23B, FIGS. 25A-25C, and FIGS. 27A-27C.

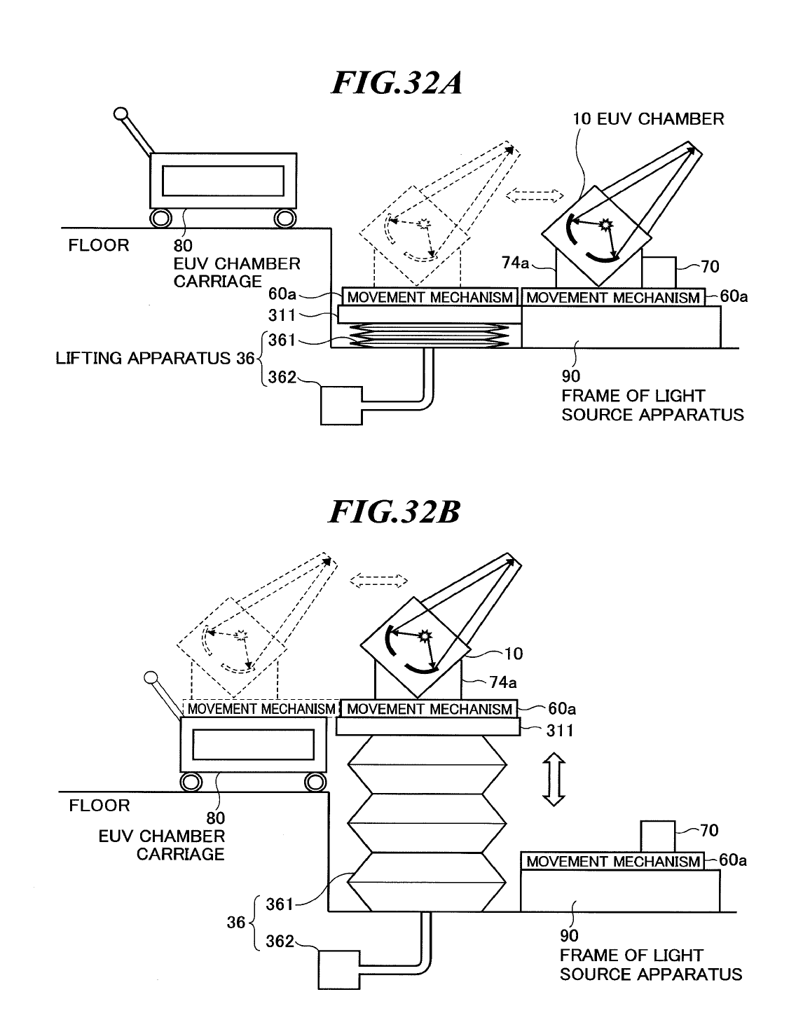

FIGS. 32A and 32B are side views showing a twenty-fifth example of the EUV light source system according to the second embodiment.

The twenty-fifth example as shown in FIGS. 32A and 32B is provided with a lifting apparatus 36 including an accordion tube 361 and a pump 362 for supplying air pressure into the accordion tube 361 in the second embodiment. In the lifting apparatus 36, the pump 362 supplies air into the accordion tube 361 or discharges the air from the accordion tube 361, and thereby, the vertical base part 311 is raised and lowered. In the example, the example in which the accordion tube 361 is operated by air pressure (e.g., air cylinder) is shown, but an example in which the accordion tube 361 is operated by oil pressure (e.g., oil cylinder) may be possible.

The lifting apparatus 36 in FIGS. 32A and 32B may be provided beneath the vertical base part 311 as the lifting apparatus 31a as shown in FIGS. 24A-24C, or may be provided at both sides of the vertical base part 311 as the lifting apparatus 31b as shown in FIGS. 26A-26C. Further, the chamber stage 74a in FIGS. 32A and 32B may be replaced with the chamber stage 74b with the wheels 741 as shown in FIGS. 23A and 23B, FIGS. 25A-25C, and FIGS. 27A-27C.

1. An extreme ultraviolet light source system comprising:
an extreme ultraviolet light source apparatus having a chamber in which extreme ultraviolet light is generated, a target supply unit for supplying a target material into said chamber, a driver laser for irradiating the target material supplied by said target supply unit with a laser beam to generate plasma, and a collector mirror for collecting the extreme ultraviolet light radiated from the plasma to allow the extreme ultraviolet light to enter projection optics of exposure equipment; and
a lifting apparatus provided to lift and move a replacement part which is apart of said extreme ultraviolet light source apparatus.

2. The extreme ultraviolet light source system according to claim 1, wherein said lifting apparatus lifts said replacement part by hoisting said replacement part.

3. The extreme ultraviolet light source system according to claim 1, wherein said lifting apparatus is fixed to said extreme ultraviolet light source apparatus.

4. The extreme ultraviolet light source system according to claim 3, wherein:
said lifting apparatus includes a lift mechanism for lifting said replacement part, and a lift mechanism frame for supporting said lift mechanism; and
said lift mechanism frame is integrated with a frame of said extreme ultraviolet light source apparatus.

5. The extreme ultraviolet light source system according to claim 1, wherein:
said lifting apparatus includes a lift mechanism for lifting said replacement part, and a lift mechanism frame for supporting said lift mechanism; and
said lift mechanism moves in a direction orthogonal to a direction of gravity force relative to said lift mechanism frame.

6. The extreme ultraviolet light source system according to claim 1, wherein:
said lifting apparatus includes a lift mechanism for lifting said replacement part, and a lift mechanism frame for supporting said lift mechanism; and
said lift mechanism frame moves in a direction orthogonal to a direction of gravity force relative to said extreme ultraviolet light source apparatus.

7. The extreme ultraviolet light source system according to claim 1, wherein said lifting apparatus lifts said replacement part by pushing up said replacement part.

8. The extreme ultraviolet light source system according to claim 7, wherein said lifting apparatus has a height not larger than a lifting height of said replacement part.

9. The extreme ultraviolet light source system according to claim 7, wherein said lifting apparatus is provided beneath a base part for supporting said replacement part from below, and vertically moves the base part.

10. The extreme ultraviolet light source system according to claim 7, wherein said lifting apparatus is provided at both sides of a base part for supporting said replacement part from below, and vertically moves the base part.

11. The extreme ultraviolet light source system according to claim 1, wherein said replacement part includes said chamber.
